(19) United States
(12) Patent Application Publication
(10) Pub. No.: US 2007/0139399 A1
(43) Pub. Date: Jun. 21, 2007

(54) Systems and methods for enabling tablet PC/pen to paper space

(75) Inventor: John T. Cook, Boulder, CO (US)

Correspondence Address: PATENT ADMINISTRATOR;KATTEN MUCHIN ROSENMAN LLP, 1025 THOMAS JEFFERSON STREET, N.W., EAST LOBBY: SUITE 700, WASHINGTON, DC, 20007-5201, US

(73) Assignee: QuietSo Technologies, LLC

(21) Appl. No.: 11/603,312

(22) Filed: Nov. 21, 2006

Related U.S. Application Data
(63) Continuation-in-part of application No. 11/287,519, filed on Nov. 23, 2005.

(51) Int. Cl. G09G 5/00

(52) U.S. Cl. 345/179

(57) ABSTRACT

A computer system includes an electronic recording system and a pen input device that is suitable for use with forms in a paperless environment and optionally a paper environment. The pen input device may be an inertial type device so that it can be used on virtual writing surfaces and may optionally be configured to have a selectable electronic edit function, such as an electronic erase, highlight and red-line function. In accordance with an important aspect of the invention, the computer system is provided with an electronic forms library. These forms are selectable by the pen input device. The pen input device may also be configured to create the forms that it uses. The pen input device is able to fill out a virtual form on a virtual writing surface and transmit the data to the computer system for recordation. The pen input device may also be configured with a voice to text function which enables boxes on a form, selected by the pen input device, to be filled in via voice commands. In accordance with another aspect of the invention, the pen input device is provided with enhanced functionality relative to known pen input devices including the ability to engage in pen peer-to-peer communication among multiple input devices including other pen input devices in an ad hoc or planned network to allow collaboration among multiple pen input devices to complete the required data on a selected form. In accordance with another important feature of the invention, the pen input device may be configured with an inking feature that can be used within a browser application which provides the ability of multi-functional pen input devices which include an electronic stylus to create a form on a tablet PC with the electronic stylus using inking in a browser application and authentication of input devices in a network. The system also includes a voice to text application to enable form data to be completed by way of voice.

### CROSS REFERENCE TO RELATED APPLICATIONS

The present application is a continuation-in-part of commonly owned co-pending U.S. patent application Ser. No. 11/287,519, filed on Nov. 23, 2005. This application is also related to commonly owned co-pending U.S. patent application Ser. No. 11/499,378, filed Aug. 4, 2006, entitled “Multi-Functional Pen Input Device”, hereby incorporated by reference.

This application includes a Computer Listing Appendix on compact disc, hereby incorporated by reference.

### BACKGROUND OF THE INVENTION

1. Field of the Invention

The present invention relates to a computer system which includes one or more input devices including at least one pen input device and an electronic recording device for recording input data including virtual pen down events including handwriting on virtual writing surfaces which provides enhanced functionality relative to known pen input devices including an electronic edit function, such as an erase function, an electronic highlighting function and an electronic red-line function, and in an alternate embodiment, the ability to allow a pen input device to be used to create forms and select and fill in forms available from a forms library stored on the remote computer system on a virtual writing surface and transmit the completed form data to the electronic recording r system for recording as well as enable peer-to-peer communication among multiple pen input devices in an ad hoc or planned network to enable collaboration amongst multiple pen input devices to complete the required data on a selected form.

2. Description of the Prior Art

Various types of pen input devices are known. One type of pen input device is known as a stylus and in particular, an active stylus. Such active stylus are normally used with Tablet PCs as well as various other devices which include a writing surface that is configured to sense electromagnetic energy as well as the location on the writing surface where the electromagnetic energy is directed. The active stylus is used to generate electromagnetic energy which is sensed by the writing surface as the stylus moves there across. An example of such a pen input device is disclosed in U.S. Pat. No. 6,806,867 and US Patent Application Publication No. US 2004/0125089 A1 to Chao et al., hereby incorporated by reference.

Other computer systems and pen input devices are known in the art which do not require writing surfaces capable of sensing electromagnetic energy. Examples of such systems are disclosed in U.S. Pat. Nos.: 6,577,299; 6,603,464; and 6,633,282; as well as US Patent Application Publication Nos.: US 2002/0011989 A1; US 2002/0163511 A1; US 2004/0125089 A1; US 2004/0140962 A1 and US 2005/0024690 A1, all hereby incorporated by reference. In general, these systems include wireless pen input devices that are linked with a remote computer system and are configured to transmit pen down events including handwriting to the remote computer system for recordation. Various types of such pen input devices are known. For example, optical, inertial and track ball pen input devices are known. Examples of inertial pen input devices are disclosed in US Patent Application Publication No. US 2004/0140962 and 2004/0125089; as well as U.S. Pat. No. 6,577,299. Examples of optical pen input devices are disclosed in US Patent Application Publication Nos.: US 2002/0011989 and US 2005/0024690 and U.S. Pat. No. 6,603,464. Chao et al US Patent Application Publication No. US 2004/0125089 also discloses an optical type pen input device which cal also be used as an active stylus. An example of a track ball type pen input device is disclosed in U.S. Pat. No. 6,633,282, all hereby incorporated by reference.

Inertial type pen input devices normally utilize inertial signals from accelerometers to determine the coordinates of the pen input device on an actual or virtual writing surface. For example, Wang et al published US patent application no. US 2004/0140962 A1 discloses a computer system which includes a pen input device for use in both physical ink and non-ink applications. The input device includes an ink cartridge, a pressure sensor, a plurality of accelerometers, a gyroscope, a processor, a memory, a transceiver, a power supply and a display. In non-ink applications, virtually any surface can be used as a virtual writing surface or tablet. In a calibration mode, the system sets the inertial co-ordinates equal to virtual paper coordinates. As the pen input device is moved across a virtual writing surface, inertial signals from the accelerometers are used to calculate the inertial coordinates of the pen input device. The inertial coordinates are used to calculate virtual paper coordinates. In situations where the velocity of the pen input device is constant, the signals from the accelerometers will be relatively inaccurate. In those situations, signals from the gyroscope are used to enhance the accuracy of the inertial signals from the accelerometers. The coordinate signals and thus the path of the pen input device, for example, handwriting, along the virtual writing surface are transmitted to a remote computer system and recorded.

Schiller et al. U.S. Pat. No. 6,577,299, hereby incorporated by reference, relates to another type pen input device. The pen input device disclosed in the '299 patent is configured to wirelessly transmit coordinate signals from the pen input device to a remote computer system. The '299 patent discloses the use of at least two reflectors that are placed along the edges of a piece of paper. A beacon, such as an ultrasonic, infrared, or RF beacon, is located on the pen input device so as to be in communication with the reflectors. The signals reflected from the reflectors are measured to determine their energy and time of flight in order to determine the reference coordinates of the pen input device. Once the reference coordinates are determined, the system utilizes inertial signals from a plurality of accelerometers and a gyroscope to determine the path of the pen input device. As such, the system is able to record handwriting on a virtual or actual writing surface. The beacon is used to periodically calibrate the coordinates of the pen input device.

U.S. Pat. No. 6,633,282 B1 to Monroe, hereby incorporated by reference, discloses a track ball type pen input device. In particular, the '282 patent discloses a track ball located in the tip of the pen input device. The movement of the pen input device across an actual or virtual writing surface is sensed in a similar manner as mouse with a track ball. The pen input device is configured with an outward appearance resembling a standard ballpoint pen which optionally operates as a standard ballpoint pen and as a pen input device. When operated as a pen input device, the position signals of the track ball are transmitted back to the computer system and recorded to record the path of the trackball along the virtual writing surface.

As mentioned above optical pen input devices are also known. US Patent Application Publication No. US 2002/0011989 A1 to Ericson et al, hereby incorporated by reference, is an example of an optical type pen input device. Such optical pen input devices include an optical scanner. An optical way point is used to enable the pen input device to determine its relative position relative to the data, for example, handwriting, to be scanned. The optical way point is provided as a pattern of dots on the writing surface. The pen input device scans the dot pattern and identifies it by conventional optical character recognition (OCR) techniques. As such, the pen input device is able to scan handwritten data and transmit it to a remote computer system along with the paper coordinates of the scanned data. The pen input device is also able to provide various properties to the scanned data, such as, underline, color, line width, yellow mark, secret, and personal and/or by perform an action on the scanned data, such as, encryption, sending an email or facsimile message, etc.

US Patent Application Publication No. US 2002/0163511 A1 to Sekendur, hereby incorporated by reference, is another example of an optical pen input device. That pen input device includes a scanner, such as a digital camera or a charge coupled device (CCD) for scanning optical data, such as handwriting data. With such optical pen input devices, optical way points are provided at one or more specific locations on the writing surface. The pen input device scans and identifies those way points. The way points are used to provide an x-y reference coordinate position so that the movement of the pen input device on the writing surface (e.g., paper) can be referenced to those way points.

US Patent Application Publication No. US 2005/0024690 A1 to Picciotto et al., also incorporated by reference, is another example of an optical type pen input device. In addition to way points, the '690 publication discloses a pen input device which also uses a velocity sensor for sensing speed and relative direction information of the writing tip over a writing surface. Data, such as handwriting data, is scanned by an optical scanner and transmitted to a computer system.

Rabin U.S. Pat. No. 6,603,464 B1, incorporated by reference, also relates to an optical pen input device for sensing handwriting and other pen down events and transmitting that data wirelessly to a remote computer system. The pen input device is configured to be used with forms to record handwriting or other data physically written on the form. The pen input device includes a scanner for scanning handwriting and other pen down events on special forms which include one or more optical way points at predetermined coordinates on the form. These optical way points are sensed and identified by conventional optical character recognition techniques. The optical way points provide a reference point for the pen input device. As such as handwriting and other data is scanned, the relative position of the scanned data relative to the form is determined relative to the way points. In this application each form to be scanned is divided into a number of fields. Each field is provided with a reference or way point. As such, data in each field on the form along with its reference point. The scanned data is stored in a database and may be used to provide an electronic version of a completed form.

Optical pen input devices are limited to applications where pen input data can be scanned and thus can only be used in physical writing surface applications. As such, optical type pen input devices are becoming increasingly less desirable in paperless office applications. Although track ball and inertial type pen input devices are not so limited in application, many applications, such as medical applications, are still form based. Heretofore, form based applications have only been handled with optical type pen input devices which are limited in application to physical forms. Thus, there is a need for a pen input device for use in a paperless environment.

### SUMMARY OF THE INVENTION

Briefly, the present invention relates to a computer system which includes an electronic recording system and a pen input device that is suitable for use with forms in a paperless environment and optionally a paper environment. The pen input device may be an inertial type device so that it can be used on virtual writing surfaces and may optionally be configured to have a selectable electronic edit function, such as an electronic erase, highlight and red-line function. In accordance with an important aspect of the invention, the computer system is provided with an electronic forms library. These forms are selectable by the pen input device. The pen input device may also be configured to create the forms that it uses. The pen input device is able to fill out a virtual form on a virtual writing surface and transmit the data to the computer system for recordation. The pen input device may also be configured with a voice to text function which enables boxes on a form, selected by the pen input device, to be filled in via voice commands. In accordance with another aspect of the invention, the pen input device is provided with enhanced functionality relative to known pen input devices including the ability to engage in pen peer-to-peer communication among multiple input devices including other pen input devices in an ad hoc or planned network to allow collaboration among multiple pen input devices to complete the required data on a selected form. In accordance with another important feature of the invention, the pen input device may be configured with an inking feature that can be used within a browser application which provides the ability of multi-functional pen input devices which include an electronic stylus to create a form on a tablet PC with the electronic stylus using inking in a browser application. The present invention also allows for collaboration of data among multiple input devices and the ability to merge data from multiple input devices and authentication of input devices in a network. The system also includes a voice to text application to enable form data to be completed by way of voice.

### DESCRIPTION OF THE DRAWING

These and other advantages of the present invention will be readily understood with reference to the following description and attached drawing, wherein:

FIG. 1 is a high exemplary level diagram of the computer system in accordance with the present invention.

FIG. 2 illustrates an exemplary virtual form for use with the present invention.

FIG. 3 is an exemplary diagram illustrating the calibration technique in accordance with one aspect of the invention.

FIG. 4 is an exemplary diagram of the software architecture of the pen input device for performing pen to paper calibrations.

FIG. 5 is a more detailed exemplary diagram of the calibration algorithm illustrated in FIG. 4.

FIGS. 6A and 6B are block diagrams of the pen input device in accordance with the present invention.

FIGS. 7A-7C are exemplary diagrams illustrating various implementations of the pen input device in accordance with the present invention.

FIGS. 8A-8E are exemplary diagrams illustrating various user interfaces for the pen input device in accordance with the present invention.

FIG. 9 is an exemplary schematic diagram of the pen input device in accordance with the present invention.

FIGS. 10 and 11 illustrate an exemplary configuration for a database for use with the present invention.

FIG. 12 is a diagram illustrating an exemplary data format for data transmitted by the pen input device.

FIGS. 13-19 illustrate exemplary web pages for a web based implementation of the present invention.

FIG. 20 is an exemplary diagram of the network for the system in accordance with the present invention.

FIG. 21A is an exemplary block diagram of a client/server configuration for the system in accordance with the present invention.

FIG. 21B illustrates an exemplary centralized pen peer-to-peer configuration for the system in accordance with the present invention.

FIG. 21C illustrates a decentralized peer-to-peer configuration for the system in accordance with the present invention

FIG. 22A exemplary software flow diagram illustrating the ON/OFF mode of the pen input device in accordance with the present invention.

FIG. 22B is an exemplary software flow diagram illustrating the NEW_PAGE mode of the pen input device in accordance with the present invention.

FIG. 23 is an exemplary software flow diagram of the calibration mode logic for a pen input device in accordance with the present invention.

FIGS. 24A-24C illustrate exemplary software flow diagrams for converting raw analog position data of the pen input device to digital data.

FIGS. 25A-25E illustrate exemplary software flow diagrams for converting the accelerometer data to X, Y position data for the pen input device in accordance with the present invention.

FIG. 26 is an exemplary software flow diagram for an embodiment of a master operation in a pen peer-to-peer implementation in accordance with the present invention.

FIG. 27 is an exemplary software flow diagram for a file transfer web application in accordance with the present invention.

FIGS. 28A-28F are exemplary software flow diagram for a forms definition web application in accordance with the present invention.

FIG. 29A-C are exemplary software flow diagrams illustrating the erase, highlight and redline features of the pen input device.

FIG. 30 is an exemplary software flow diagram illustrating a feature which enables inking by an electronic stylus on a tablet PC within a browser application

FIG. 31 is an exemplary software flow diagram of an ink XML application for a pen input device.

FIG. 32 is an exemplary software flow diagram illustrating the creation of a form by a pen input device.

FIG. 33 is an exemplary flow diagram illustrating the collaboration of data on a form by one or more pen input devices and one other input device which may be another pen input device.

FIG. 34 is an exemplary flow diagram illustrating an application of using voice data to complete text boxes on a form.

FIG. 35 is an exemplary flow diagram illustrating an authentication feature for the input devices forming a network.

### DETAILED DESCRIPTION

The system in accordance with the present invention relates to a computer system which includes one or more input devices, such as pen input devices and an electronic recording system. In one application of the invention, the electronic recording system receives data from the pen input device in order to fill out virtual forms in a paperless environment, for example, on a form template and optionally a paper environment. The pen input device may be an inertial type device and may include one or more of an ink cartridge, a pencil lead cartridge or a stylus, for example, as disclosed in commonly owned co-pending U.S. patent application Ser. No. 11/499,378, filed on Aug. 4, 2006, hereby incorporated by reference, or a beacon type device, for example, as disclosed above, so that it can be used on virtual writing surfaces and may optionally be configured to have a selectable ink mode in which the pen input device can be used as a conventional ball point pen. Virtually any inertial or beacon based pen input device can be used with the present invention.

In accordance with an important aspect of the invention, the computer system is provided with an electronic forms library. These forms are selectable by a conventional input device, such as a mouse or by a pen input device. The pen input device is able to fill out a virtual form with raw data on a virtual writing surface and transmit the data to the electronic recording system for recordation. The raw data as well as, form meta data, i.e. data identifying the form, may be transmitted to be sent to other pen input devices and merged with other data or modified and re-transmitted to other pen input devices, as necessary.

In accordance with another aspect of the invention, the pen input device is provided with enhanced functionality relative to known pen input systems including: an electronic edit function, such as an electronic erase function; an electronic highlight function; and an electronic red-line function. The electronic recording system can also enable multiple pen input devices to engage in pen peer-to-peer communication in an ad hoc or planned network to allow collaboration among multiple pen input devices, for example, to complete the required data on a selected form. The system also allows for peer to peer communications between pen input devices and devices other than pen input devices, such as computer systems. Moreover, the system enables configuration data for the pen input devices to be downloaded from an application running a remote computer.

### System Overview

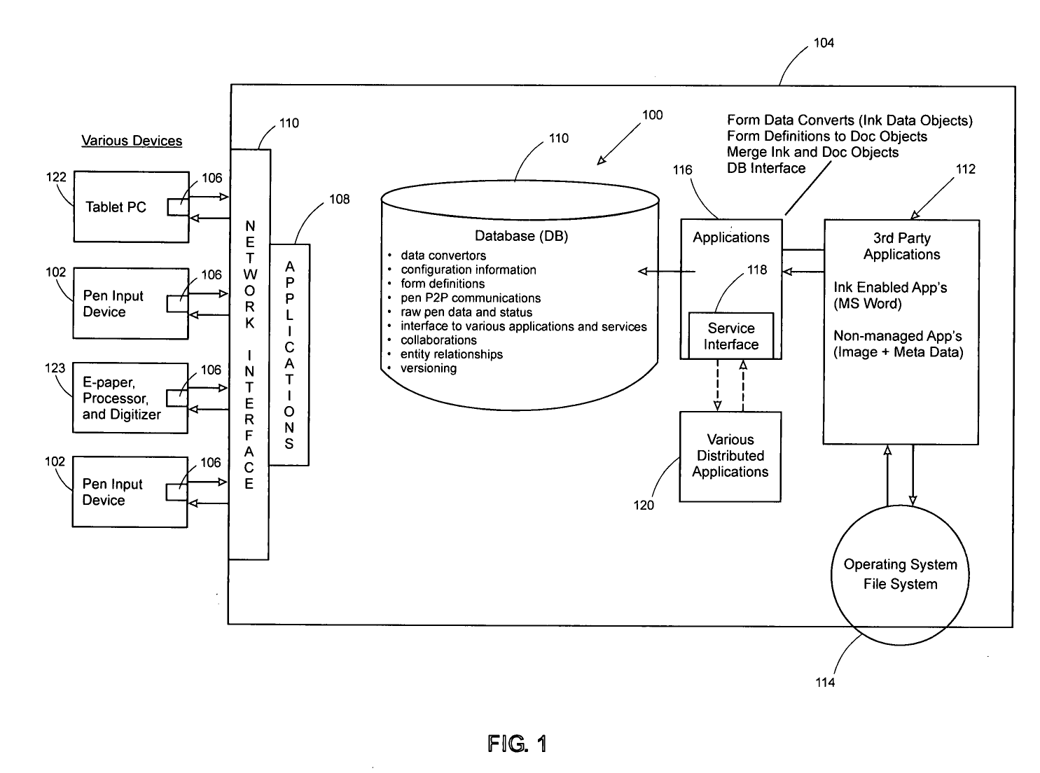

Referring to FIG. 1, a high level diagram of a computer system 100 which includes an electronic recording system 104 for use with one or more pen input devices 102, as well as other devices, such as a tablet PC 122 and an e-paper and processor and digitizer 123 in accordance with the present invention. The input devices 102, 122 and 123 may be coupled to the electronic recording system 104 by way of a conventional network interface 106, for example, as described below.

The electronic recording system 104 may be implemented as a tablet PC, for example, shown within the box 104. In particular, the electronic recording system 104 may include a database 110, resident on the tablet PC or resident on one or more other computers (not shown) by way various applications, such as the applications identified with the reference numerals 116, 118 and 120. The electronic recording system 100 may also include one or more applications for interfacing the input devices (i.e. 102, 122 and 123) to the data base 110. The electronic recording system 104 may also include one or more third party applications 112, for example, ink enabled applications, such as Microsoft Tablet PC SDK Technology, Ink Tutor. Tablet Dictionary Manager by AcuLearn and Blackboard by Blackboard, Inc.

Various operating modes for the system 100 are contemplated. In a master slave mode, a single pen input device 102 acts as a slave to the electronic recording system 104. In a multiple pen input device 102 environments, the pen input devices 102 may be configured to communicate with each other on a pen peer-to-peer basis as well as with the electronic recording system 104 by way of a network interface 106. The pen input devices 102 may also be configured to communicate with other input devices, such as other computer systems. Although the electronic recording system 104 is normally considered to be the master 108, operating environments which include a large number of pen input devices 102 can have multiple masters.

Each input device, such as a pen input device 102, in the network must be configured. As such, each pen input device 102 may be provided with a minimum of two unique ID's., for example. In particular, each pen input device 102 comes with default settings. These settings may include the following:
unique ID of the pen input device 102
unique ID of the master 108.

As discussed in more detail below, to communicate with another pen input device 102, the sending pen input device 102 verifies that the receiving pen input device 102 has a unique ID that is listed in the pen configuration stored in the electronic recording system 104. The receiving pen input device 102 also verifies that the unique ID of the sending pen input device 102 is loaded in its configuration information. If both of these comparisons are true, communication is enabled between the two pen input devices 102.

There are several exemplary ways to add a new unique ID's to the configuration information of a pen input device 102.
downloading a new configuration from the master computer system
to trade unique ID's after asking the user to accept the unique ID's
to trade a temporary unique ID that allows communication for a group of transactions (e.g., exchanging form information for collaboration)

The first way is for a master 108, to download new unique IDs into configuration information of a pen input device 102. In this case, the master (i.e. computer system 104) and the pen input device 102 verify that they can communicate with each other (i.e. establish a wireless communication link). The master 108 then downloads new configuration information to the pen input device 102. The new configuration information contains unique IDs, etc. Alternatively, a pen input device 102 can poll or search (e.g., wireless network) for other pen input devices 102 and ask the other pen input devices 102 in the network if it can communicate in the manner discussed above. If so, a communication link is established (also known as a hand shake). The ability of the pen input devices 102 to communicate with each other has various benefits, such as the ability to trade notes with meeting members and also provides for strict network definitions based on organization policies.

The pen network interface 106 may be configured so that the pen peer-to-peer network software rides on top of standard network protocols, such as Ethernet, wireless IEEE 802.11b, as well as other conventional network protocols. The network interface 106 may be configured to support encryption, such as RSA encryption technology or other standard or non-standard encryption techniques. Like any peer-to-peer network, the pen peer-to-peer network may be a local network or distributed, for example, over the Internet. The principles of the present invention are applicable to both ad hoc and planned networks.

The network interface 106 may be used to connect the pen input device 102 to gateways to allow communication with other pen peer-to-peer networks. The pen peer-to-peer network takes into account the intermittent nature of Internet like protocols, using such techniques as retries. More particularly, the Internet does not guarantee transmissions. Connections are sometimes dropped. The pen input devices 102 communicate with the electronic recording system 104 by way of application software 108, which may be conventional communication software, resident on a single computer, or distributed across multiple systems over, for example, the Internet. In particular, the computer system 104 includes a network interface 106 for interfacing with one or more pen input devices 102, as well as other computer systems 104 connected, for example in a local area network (LAN) as well as to gateways to communicate with other peer-to-peer networks.

The network interface 106 may also be configured to interface the pen input device 102 to other computer systems 104 and miscellaneous devices, such as cell phones. The network interface 106 may be used to establish communication links on a wired or wireless basis. The network interface 106 may also used to download small programs (e.g. Java applet) to provide additional functionality, such as provide the ability of the pen input device 102 to email pen form information or provide an application that may connect to, for example, a peer-to-peer network of various input devices, such as pen input devices 102 The application may also provide functions, such as, emailing and interfacing to enterprise applications.

The pen input device 102 may be provided with one or more electronic edit functions, such as erase, highlight and red-line. In particular, the electronic edit functionality works in a similar manner as the pen input device 102 in an ink mode. For example, whenever the user makes a mark on a writing surface, the pen input device 102 logs the position data. In an erase mode, the pen input device 102 operates in essentially the same way. Specifically, anytime the user writes on a writing surface using the pen input device 102, the pen input device 102 records the position data for the path of the pen input device 102 on the writing surface.

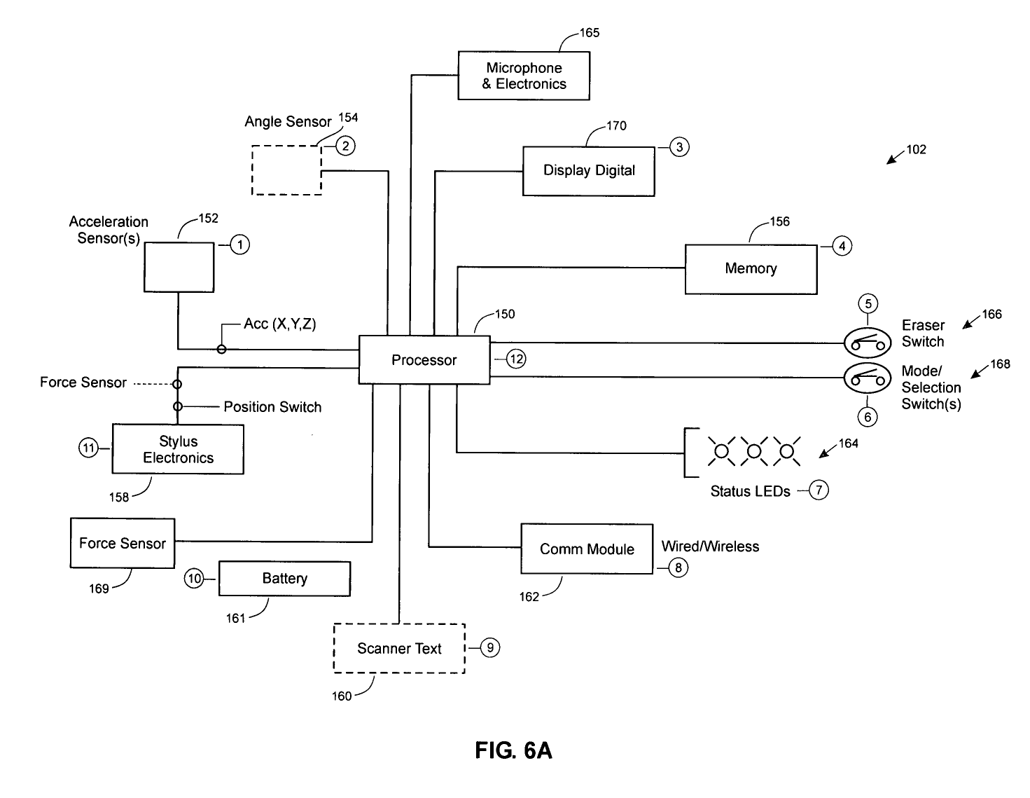

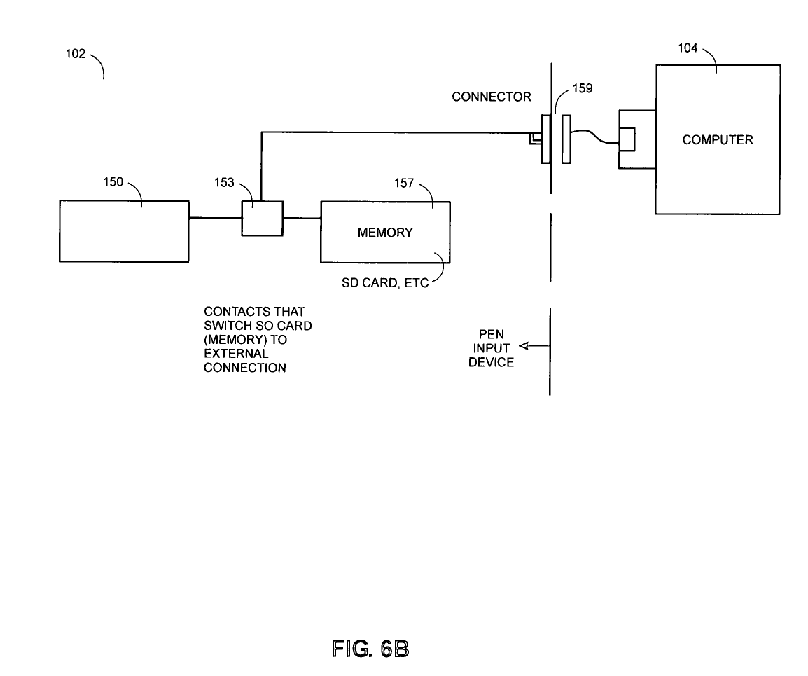

A force sensor or position switch 168 (FIG. 6A) may be used to indicate that the writing end of the pen input device 102 is being pressed against the writing surface. An optional force sensor or position switch may also be used to indicate an opposing or eraser end of the pen input device 102 is being pressed against the writing surface. Accordingly, in an electronic erase mode, the erase mode is actuated when the user turns the pen input device 102 over and presses the eraser to the writing surface or alternatively depresses an erase button (not shown). As the user erases, virtually or, for example, the physical markings in an application in which a multi-functional pen input device is used with a lead cartridge, the pen input device 102 logs the eraser's position information just like when the pen input device 102 is actually making marks on the surface. The difference being that the device logs the eraser's position switch 166, status instead of the cartridge/lead switch status. This is accomplished by using different position switches 166, 168. Electronic erasing occurs when device's data is converted to form data. Electronic erasing is done by deleting position information that corresponds to eraser position data. The user may decide to store all of the raw data in the database 110 and perform the erase function at a later time. This allows for versioning and collaboration among multiple input devices connected in a network.

The pen input device 102 may be configured for different eraser sizes and pen stroke sizes. That means that the eraser's position data may be, for example, x,y+/−5-25 mm. Any position information within the eraser's data range is thus removed from the final form data. This insures that all the electronic marks are removed from the form 124, therefore, accomplishing electronic erasure of the raw data. The user may then write in the erased area like it is a blank part of a form. The collection of the erased data enhances the collaboration functionality by offering reporting of comments. This may be used for knowledge-based applications, etc.

As mentioned above, the pen input device 102 may be provided with other electronic edit function, such as an electronic highlight function and/or an electronic red-line function. Highlight events are collected like an erase event. Highlight/redline functions also work with an ink cartridge configuration. Similar functionality may be included for a highlighter/redline modes. The difference being the information does not delete stroke data, but collects information to be overlaid on top of the form information. The highlight and red-line functions operate in a similar manner as the erase function described above.

The electronic edit data (i.e. erase, highlight, and redline information) may be stored in the electronic recording system 104. This data may also be provided on the pen input device 102. When highlight information is transferred to the electronic recording system 104, the information may be displayed on a computer (e.g., a tablet PC). The information may be stored with the form data. Also, a report may be generated that lists all the erased, highlighted or red-lined information. This could be useful for a student taking notes in a class and then having the highlighted information given to the user.

Referring to FIG. 1, the electronic recording system 104 includes application software 108 which may include the following software components: configuration, forms definition, device groups, forms groups as well as a database interface. The application software 108 may provide various functions including:
Merging of collaborative form information into a new collated form 124. Then sending of the new form's meta definition to pen input devices 102 for further mark up and collation. Detailed information may also be sent.
The use of tailored queries to collate form information and other system's data for reporting (list of highlighter information), transactions, etc.
An exemplary application to send/receive form information over a network (e.g., Internet, etc.) and offering separation of various group's data (e.g., companies', etc.).
Smoothing position form data such that “jerks” between data points are reduced (e.g., drawing a straight line between two successive data points). Also, a feature to make markings when converted for use in a form application clearer to see—essentially defining a color range around the marking and changing the pixels around the marking to the primary color. The color range will convert the color pixels to the primary color. This will enhance the markings presentation. That is, conversion frequently converts a stroke (e.g., a letter) to the primary color with various shades of the primary color around the stroke thus making the presentation not as sharp as it could be An, exemplary application may be used in various situations. An example is by placing a color tolerance around the selected color. All colors in this range or selected area are run through the conversion process. The conversion may be done for various formats (e.g., tiff, gif, PNG, etc).

Creating a multiple page form 124 by adding different forms as additional form pages. This is different from the forms group functionality discussed below.

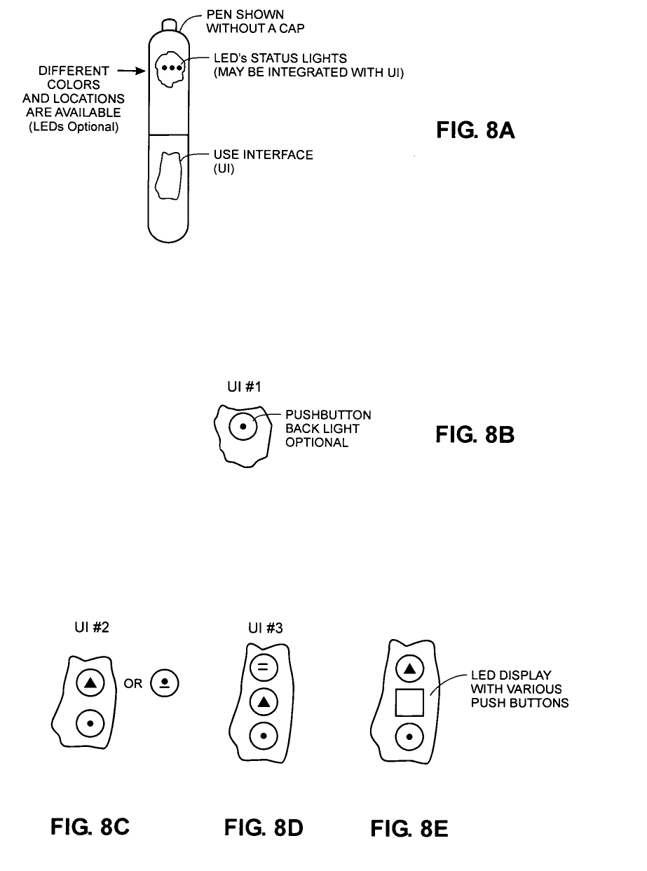

The “Configuration” software component relates to the configuration of each type of pen input devices 102 on the network. Although only a single type of pen input device 102 is described herein, the system can accommodate different types of pen input devices 102 which have different user interfaces, such as different numbers of buttons and LEDs, etc. Exemplary user interface configurations are illustrated in FIG. 8 and described in more detail below. The configuration software component may also be used to store a default configuration for the pen input devices 102, which is modifiable by the user. In addition, the configuration software component causes the following exemplary information to be stored for each pen input device 102 in the pen peer-to-peer network.
unique ID for the pen input device 102
unique ID for each of the various devices 122 that the pen input device 102 can communicate with over the pen peer-to-peer network
form numbers
number of forms supported
form type tied to form number
form definition disabled
number of calibration points (this ties the digital for 124 to the actual size of the paper)
sensor update rate
form document collaboration disabled
sensor sample rate
analog to digital algorithm
roll compensation enabled
x, y, and time position storing rate
form data, raw data and meta data send enabled
form data, raw data and meta data received disabled
form meta definitions
pen peer-to-peer network search disabled
exchange unique ID's with a pen peer-to-peer pen input device 102, computer/tablet pc, etc.
send/receive status information
eraser disabled
force sensor disabled
text messaging disabled

The “Forms Definition” software component includes specific information about each form 124 in a forms library. In particular, the form definition is the digital definition of a paper form. As used herein, a blank writing space is a blank form. A form 124 with different sections/fields (e.g., Doctor's patient record) is also a form. Each type of form 124 is given a unique name and number and the maximum number of pages. For example, a blank form 124 could be form #1 in a pen input device 102. Form 1 could have a maximum number of pages say 40. Form 124 can be defined on a computer/tablet pc and/or via a pen input device 102 and/or a third party application. Forms can also be created by an inking application within a web browser, as described in detail below. Form definitions via the pen input device 102 are accomplished using the form calibration functionally.

Exemplary meta data for a simple form 124 may include the following: unique form number, form paper size, number of text boxes, number of field boxes, then the position and text information as required for the text and field boxes. At a minimum, a pen input device 102 requires a form number or other identification so the form information can be correlated to a specific form 124. If no form data is provided, a blank form is assumed.

As used herein, meta data is distinguished from raw data and form data. In particular, as used herein, raw data is defined as the X,Y data of the pen input device. Form data is defined to be the data entered into the various boxes or fields on the form by way of an inking application or by way of voice to text data.

A function can be linked to a form 124 or area/field 124,126 within a form 124. The function-to-form 122 may be classified as a type of form 122. When the form definition is transmitted to a pen input device 102 that recognizes the type, a predefined action is accomplished. This could be as simple as sending a text message to a pager or as intricate as a web service that interfaces with a company's Enterprise Response Planning (ERP) system. It may also be performed when the form data is sent to the electronic recording system 104. The pen peer-to-peer network enables functionality that can integrate with various components and provide functionality that is much better than existing technology.

As mentioned above, the system 100 is amenable to various network configurations. The “Device Groups” software component maintains the unique IDs of the various pen input devices 102 on the network. This software component also gives the pen input devices 102 the definitions to enroll in the network.

The “Forms Group” software component keeps tracks which of the various forms 124 available in the forms library that are downloaded to specific pen input devices 102. This software component is also responsible for downloading form definitions to the various pen input devices 102 and receiving information from the pen input devices 102 and storing the data from the pen input devices 102 in an appropriate record in a database 110 for later processing of a filled out form 124.

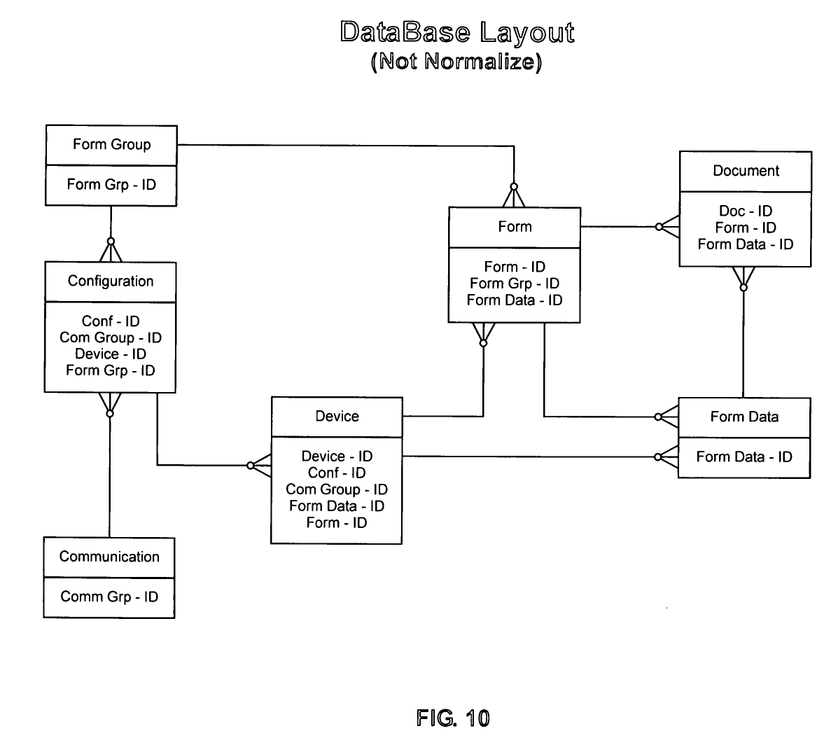

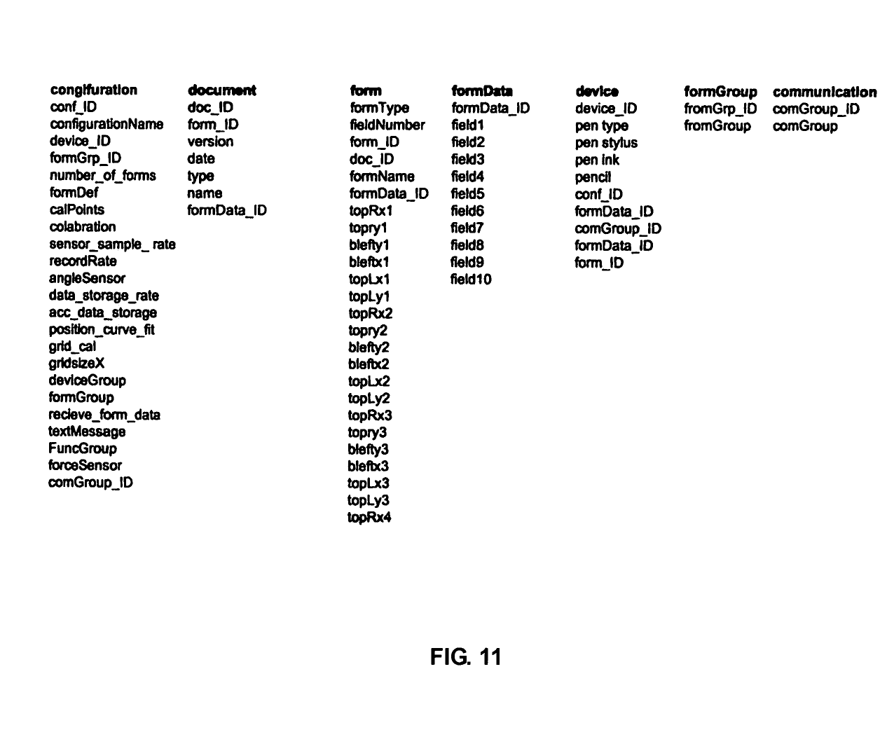

The application software 108 also includes a “Database Interface” software component 118. The “Database Interface” software component 116 is for interfacing with a database 110. The database 110 may be resident on the computer system 104 or resident on a separate computer system 104 or distributed. The database 110 is a data store for many applications, such as the configuration and form definition applications. The database 110 also acts as a data store for various data, such as: raw position data, pen peer-to-peer communications; raw pen data and status; collaborations, entity relationships and versioning, etc. An exemplary layout for the database 110 is illustrated in FIGS. 10 and 11. Alternatively, a file system could be used for storage or an object oriented database 114.

Once the data fields or boxes of a form 122 are filled in, it needs to be converted to a useful format (e.g., digital ink for use on a computer system application, text for indexing and searching, etc). This converted form information also needs to be converted back into a format that the pen input device 102 can use. An exemplary implementation of a re-conversion can take place after an ink enabled application modifies the documentation. To enable conversion and communication, the pen input device 102 may store form information with time and position. The information can be sent to other components either in raw format or as converted form information. Additional information could be the various calibration points, form number, number of pages, etc. An example of conversion is when the form information is sent to a computer/tablet pc. The form information can be stored, converted to any number of ink formats (e.g., digital ink), converted to a document, written on via the computer system 104, converted back to form information, transmitted to one or more pen input devices 102 where a hardcopy(s) of the document may be marked on and the cycle repeats itself. What is important is the conversion to various formats that can be used on other applications, the resending to the pen input device 102, the pen input device 102 doing its operations, then transmitting the information to various components on the pen peer-to-peer network.

Similarly, the form information may be modified and only the form meta data sent to a pen input device 102. This may be as simple as the form number and number of pages. For example a user may mark-up a hard copy of the converted form information. The form data recorded for the form 124 associated with the form meta data is resent to the computer system 104 and the cycle of editing and processing may take place.

Various third party off the shelf applications 112 may be used to convert ink data and form definitions to document objects or the database 110 may provide this functionality. For example, application APIs may be used to provide the functionality described herein. For example, form data and form definitions from the database 110 may be converted to document objects using Microsoft dll's Word or .NET. Likewise, implementation may be provided that enables inking via a browser. For example, the third party off the shelf applications 112 may be used to support both ink-enabled and non-ink enabled applications. In non-ink enabled applications, the ink data can be used as information data from the XML application or embedded like an OLE, etc. Forms 124 are treated separately from ink data. As such, the ink data information is overlaid on top of the form 124. A back end application interface software component 116 may be used to provide an interface with the database 110 and also act as a go between for accessing the database 110 and transferring ink data and form definition data to the third party application software components 112. The back end application interface software component 116 may also receive the converted form document from the third party application software components 112 and/or from applications integrated with the database 110 (e.g., reporting, etc.)

Raw data, meta data and form data may be transmitted in a standard format inkXML as discussed in detail below. Data may be readily available via direct pen connections or via an API. This is an enhancement to the currently proposed inkXML standard. Form data is separate from meta data. A form number may be sent to one or more pen input devices 102. The user may then write on the form 124. The data is collected. When data is sent to a computer 104, the form number may be used as a tie to the remaining form meta data. This enables collaboration in that several pen, as discussed in more detail below. The various pen data may be combined and manipulated either via an application 108 or through a database 110. This information may be sent and resent to various pen input devices 102 for various uses. The use of meta data allows a simple way to enable data exchange and manipulation. Likewise, raw data may be transmitted to various devices (e.g., pen input devices 102) for the user to use as they see fit.

### Exemplary Form

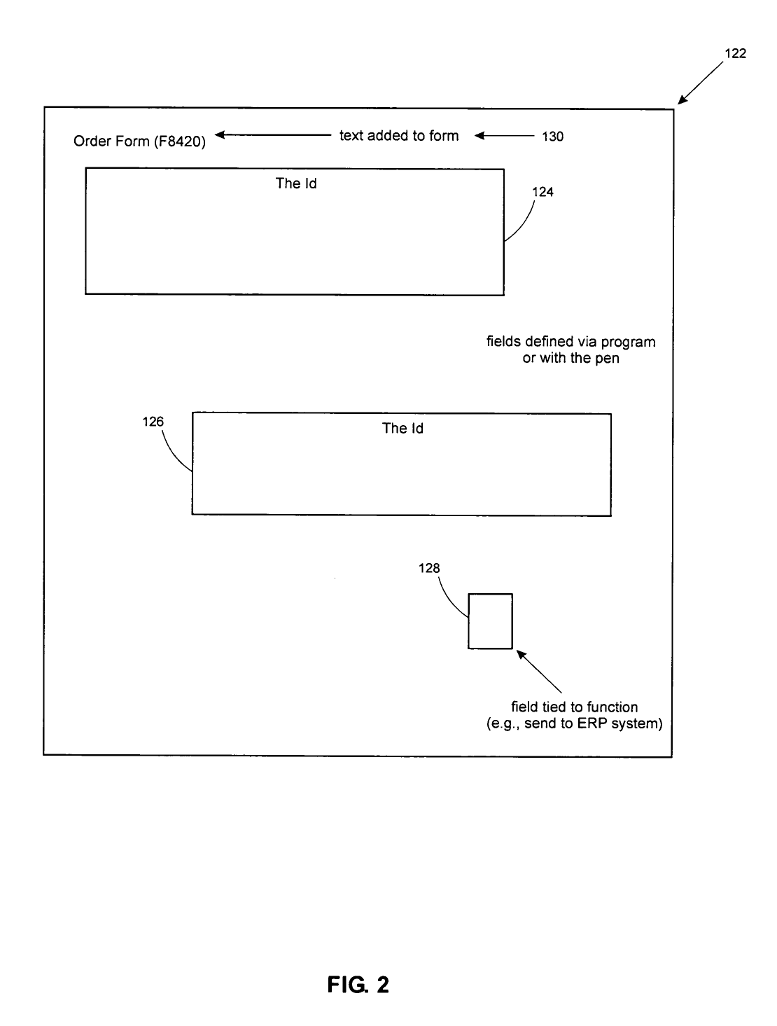

An exemplary form 124 is illustrated in FIG. 2 and generally identified with the reference numeral 124. Each form 124 may include one or more data fields 126, 130 and 132, as well as a function field 128, as discussed above. The form 124 may also include text, generally identified with the reference numeral 130, outside of the fields 126, 128, 130 and 132 and the function field 128. Each form 124 is assigned a type and a number. The field definitions and functions tied to each form 124 are also identified. The form definition (i.e. meta data) is saved separately from the detailed form data. Data can be entered into the data fields 126, 128 and 132 by way of the computer system 104 with standard text or by way of digital ink applications, a tablet PC/electronic stylus and/or by way of one or more pen input devices 102, as discussed above.

### Calibration

If a digital form 124 is not linked to a writing surface, the data may be useless. Therefore, a calibration mechanism is provided. The form calibration provides several functions:
Define the top edge and left side of the writing surface
Using three or four calibration points or more, the boundary of the writing surface is defined. The form 124 is then scaled to the paper size. For example, a blank form 124 could be 8.5′×11.5″ or 14″×17″ or any other size given the sensor technology used to implement the pen hardware platform.
When no calibration is done, the outer edges of where the pen input device 102 is used are recorded and a paper size is selected based on standard paper sizes. Of course, this can be adjusted.
When the form definition mode is selected for the pen input device 102, the selected fields are recorded relative to the calibration events. This is an easy way to define or convert existing paper forms to digital information.
The form calibration is also used when a user stops using the pen input device 102 and then wants to continue using the pen input device 102 on the form 124 again. The user can either calibrate by using one point on the top edge and left side of the writing surface or calibrate from the last point written on the surface.
The real-time calibration is also used to allow various sensing technology to be used (e.g. inertial sensors, beacon configurations, etc). This is accomplished by defining a physical point on the writing surface that the relative sensors can measure from to calculate x, y positions on the writing surface. Each major physical point is defined relative to a virtual grid.

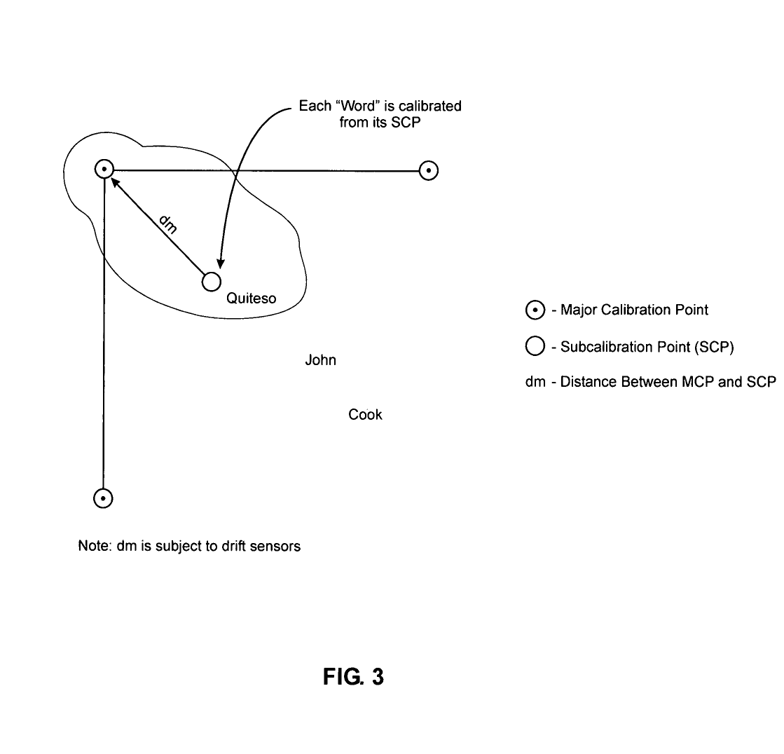

One of the problems with using certain sensors to make relative measures is measurement errors (i.e. measurement uncertainty). Drift errors are a major component of measurement errors. For example, acceleration sensors accumulate drift error with use without a calibration. Current state-of-the-art sensor technology has greatly reduced drift errors but not enough to make its use in a pen input device 102 viable for many applications. As such the calibration technique in accordance with the present invention overcomes these limitations. Specifically, it eliminates the need for absolute measurements from a variety of beacon implementations, for example, as disclosed in Rabin U.S. Pat. No. 6,603,464. FIG. 3 illustrates an augmentation to the form calibration functions describe above.

The form calibration functions still work as indicated. However, to reduce drift errors in various implementations, sub-calibration points (SCP) can be performed at each writing point, illustrated in FIG. 3. The number of major calibration points (MCP) variable based on the number of virtual grid boxes defined. A writing point is defined as a point that occurs when a user starts to make a mark on the writing surface. In this implementation, the writing point is also a SCP.

The distance between a MCP and a SCP is subject to drift errors. These errors can accumulate enough to make the use of acceleration sensors not viable. But by treating the MCP as a rough measurement and the SCP as a very fine measurement, the drift errors can be reduced to overcome the measurement error problems. Optionally, each MCP can be linked with virtual grid points on the work space. This enables a finer rough measurement. The grid points may be as large as the whole writing surface. This is made possible by a user's natural writing style. For example, assume a user starts writing on a writing surface within a 5 mm area. It is not all that important to know if this initial mark is +/−2 mm either way. But what is important, is that measurements taken from the initial mark are within a much tighter tolerance, say 0.5 mm. This means that the system can use a wider tolerance for a MCP initial placement and make further measures more precise from the initial course measurement. The practical advantage is that sensors with drift errors can be “rezeroed” while the user naturally writes, thus overcoming the constant increase in drift errors that would make the position measurement too inaccurate for many applications.

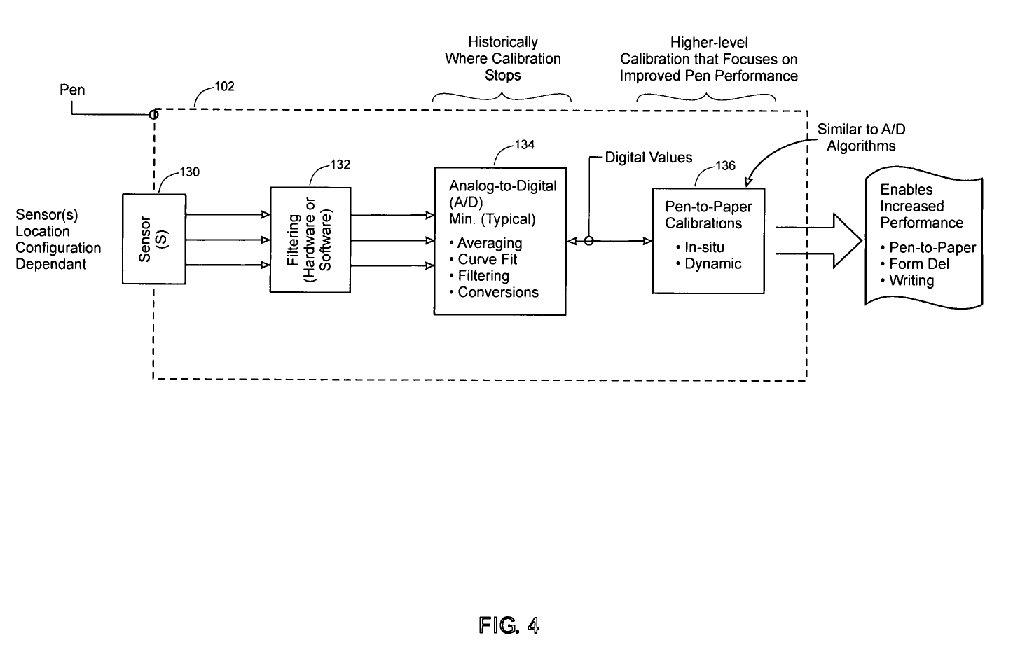

FIGS. 3 and 4 illustrate an exemplary analog to digital converter (ADC) algorithm 134 that can be used in conjunction with the above calibration schemes to further reduce errors. Such ADC algorithms 134 cover several categories. The basic ADC algorithms 134 are all within the ordinary skill in the art and may include several of the schemes below as enhancements when used in a pen input device 102.
analog filtering
over-sampling
averaging of sample (3000 Hz signal is reduced to a 600 Hz signal by averaging)
using standard curve fits from manufacturer's calibration coefficients.
doing a 10 point calibration with the pen input device 102 for the full-scale x,y measurements on a typical writing surface. This compensates for linearity and hysteresis errors.

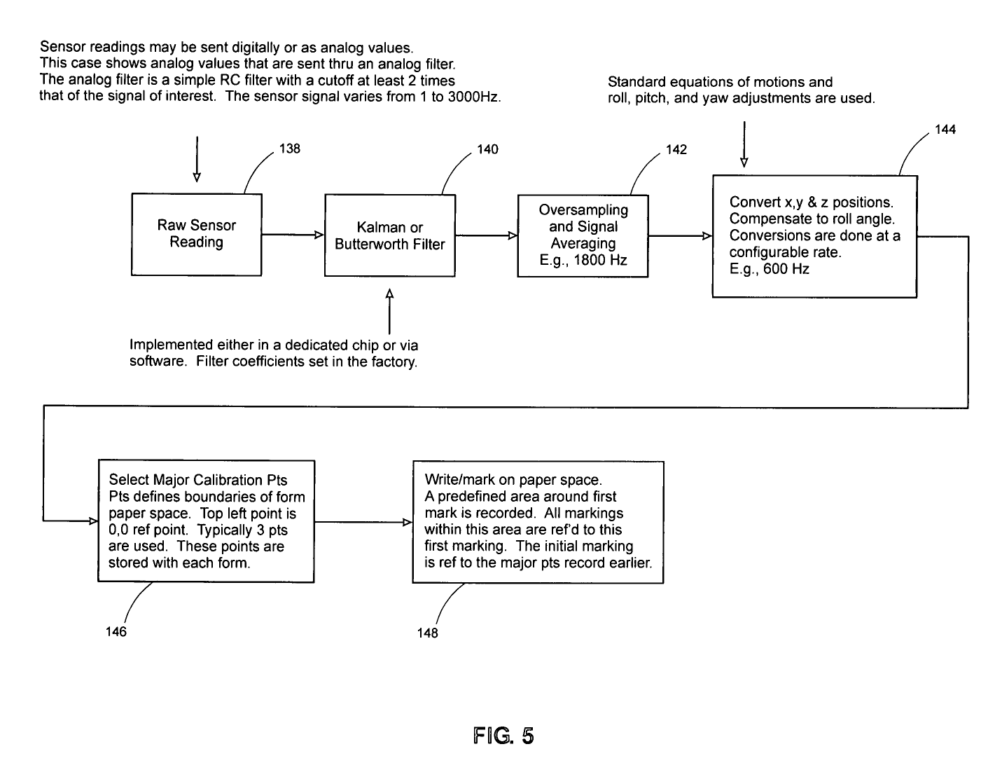

The algorithms, illustrated in FIGS. 4 and 5, can be used to further reduce the coarse (or MCP) point errors relative to a writing surface. By reducing the coarse readings, the measurement error (i.e. measurement uncertainty) is well within a user's natural writing style. On the other hand, the measurements relative to each course reading are accurate enough to be used with various recognition software packages.

The pen to paper calibration is done locally and optionally may be done via a program in the computer system 104 by the pen input devices 102. The calibration algorithm is illustrated in FIGS. 4 and 5. FIG. 4 is a general data flow diagram of the pen input device 102, while FIG. 5 is more detailed. Referring first to FIG. 4, the pen input device 102 includes a sensor 138 raw pen data. As indicated above, the sensor 130 can be virtually any type of non-optical sensor, such as an inertial type sensor or a track ball sensor or multiple sensors (e.g. relative sensors with a coarse beacon implementation). Initially the raw sensor data is filtered by a filter 132. The raw sensor data is analog. This raw sensor data may be further processed as analog data or digital data. If processed as analog data, the raw sensor data may be filtered with standard hardware 132. Alternatively, the raw sensor data could de converted to digital form 124 by way of an ADC 134 and filtered by way of a digital filter 132. Assuming the signals are being processed in analog form, the analog signals are converted to digital form by the ADC 134. The digital values from the ADC 134 may then be converted and used for pen to paper calibrations 136, which, as discussed above, may include in situ calibration, as well as dynamic calibration 136.

A more detailed exemplary data flow diagram of the calibration algorithm is illustrated in FIG. 5. Initially, raw sensor readings are received from the sensor. As shown, the raw sensor readings are initially processed as analog data that is filtered by a simple RC filter with a cut-off twice the frequency of the signal frequency 138, 140, 142. In the case of the pen input devices 102, the signal frequency is expected to vary from 1 to 3000 Hz. As mentioned above, the raw sensor readings may also be converted to digital form and filtered by a digital filter 132. The digital filter, for example, a Kalman or Butterworth filter 140, can be implemented in software or by way of a dedicated integrated circuit with factory set co-efficient. The filtered signals are then digitized by an ADC 134, for example, the on-board ADC on an MPS430 model microprocessor which has a 12-bit delta sigma ADC included.

The pen input device 102 includes triaxial mounted accelerometers 152, as well as an angle sensor 154. The raw data from the triaxial mounted accelerometers 152 and the angle sensor 154 are converted to x, y, z position data of the pen input device 102 using standard equations of motion which include adjustments for roll, pitch and yew. Exemplary equations are provided below.

rotation about Z-axis
↓
Xacceleration = Xacceleration * cosine(Gyro_{z})−Yacceleration *
sine(Gyro_{z})
$Pitch = arctangent [ \frac{Xacceleration}{{[ {Yacceleration}^{2} + {Zacceleration}^{2} ]}^{1 / 2}} ]$
$Roll = arctangent [ \frac{( Xacceleration )}{{[ {X acceleration}^{2} + {Zacceleration}^{2} ]}^{1 / 2}} ]$

| Xacceleration − adjuested = | Xacceleration * cosine (pitch)+ | |
|---|---|---|
| (ACCXIADJ) | Yacceleration * sine (roll) * sine (pitch)− | |
| | Zacceleration * cosine (roll) * sine (pitch) | |
| Yacceleration − adjusted = | Yacceleration * cosine (roll)+ | |
| (ACCYIADJ) | Zacceleration * sine (roll) | |
| | ACCXI = ACCxIADJ | |
| Velocity → | Vx = Vxo + ACCXI*DE-T DEL-T˜ | |
| | change in time per sample | |
| | Average Vx (AVEVx)=(Vx+Vo)/2 | |
| | Delx = AVE Vx * DEL-T | |
| | ↑ | |
| | change in X position | |
| | X = | Xo * DELX |
| | ↑ | |
| | position | ↑ initial X position |
| | ACCXO | = ACCXI |
| | ↑ | |
| | new initial acceleration is current ACCXI | |
| | Vxo | = Vx |
| | ↑ | |
| | new initial V is current Vx | |
| | Xo | = X |
| | ↑ | |

new initial X position is current position
repeat above for Y (position)

The x, y, z position data is determined in step 144 and is optionally compensated for roll angle. Translation along the y-axis may be needed based on the sensor location within the pen input device 102. The conversion rate may be configurable and done, for example at 600 Hz. Next in step 146, parameters are selected. These points define the boundaries of the form paper space. For example, the top left corner of the form 124 may be used as the 0,0 reference point. Three points may be selected and stored for each form 124. Otherwise default reference points are used, as discussed above. In step 148, sub-calibration is performed as discussed above. In particular, the pen input device 102 is used to mark or draw on the form 124. FIG. 3 illustrates the MCP and the SCP calibration process.

### Pen Input Device

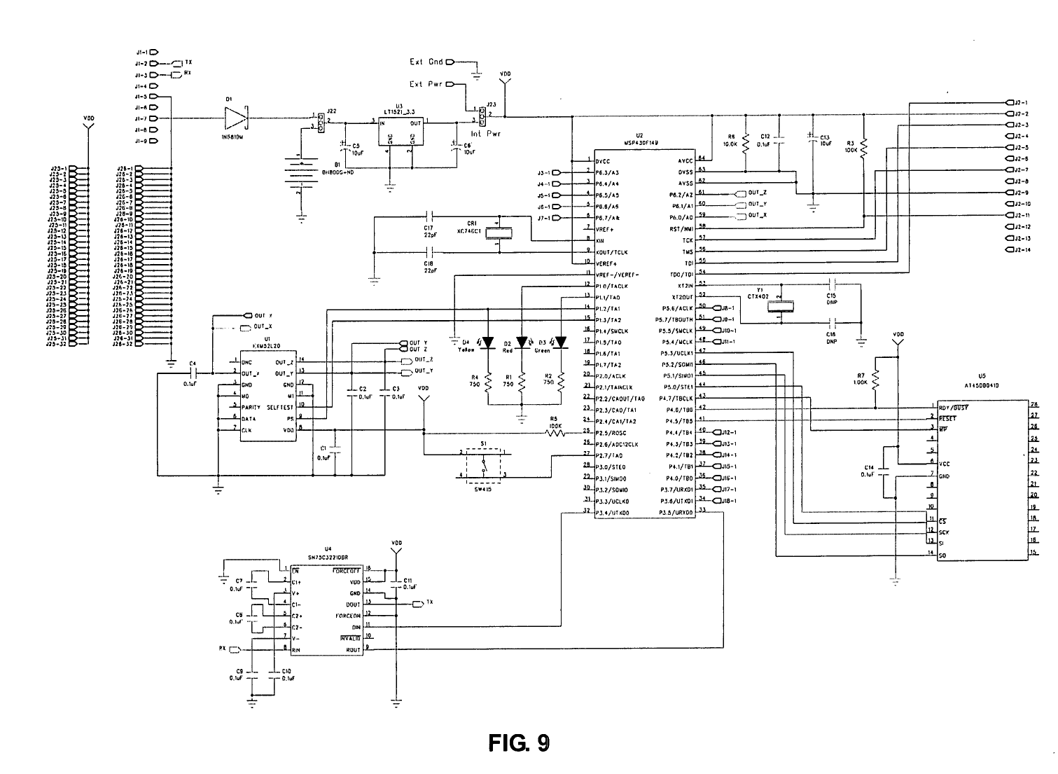

FIG. 6A is an exemplary block diagram of the pen input device 102, while FIG. 9 is an exemplary schematic diagram. Referring first to FIG. 6A, the pen input device 102 includes a processor 150, acceleration sensors 152, an angle sensor 154, memory 156, an optional stylus electronics 158, which may be separate from the pen input device 102 electronics, an optional scanner 160, a battery 161, a communication module 162, which may be wired or wireless, status LEDs 164, an optional eraser switch and/or highlighter/redline switches 166, a mode selector switches and push buttons 168, a force sensor 169 and a display 170. The pen input device 102 may also include a microphone 165 for embodiments that include voice to text applications for filling in form data.

Exemplary components for the pen device 102 are as follows:
152: Kionix KXM52 MEMS Tri-Axis Acceleration Sensor—x,y only can be used in certain configurations.
154: Kionix Gyroscope (optional).
170: Generic miniature digital display (optional).
156: Amtel AT45DB041B 4Mbit flash memory. Memory size may vary (other manufacturers may be substituted).
166: Generic eraser and/or highlighter/redline switches (optional).
168: generic limit switches and pushbuttons
164: Generic status LED's (optional).
162: Communication module wired USB, serial, etc. Various wireless supported.
160: Text scanner module (optional).
161: 6 VDC supply voltage. Not required if USB wired configuration is used (other power supplies and power levels may be needed based on actual parts used).
158: WACOM Compatible Stylus with position switch, separate from the pen input device 102 electronics.
150: Texas Instruments MSP430F149 Processor (other processors may be substituted).
169: Force Sensor—Same as Item 152. A force signal can be derived from an accelerometer signal in a conventional manner or alternatively an activation switch can be used.

The implementation illustrated in FIGS. 6A and 9 supports the following:
Sensor bandwidths up to 3000 Hz
Position resolution from 5 mm to 0.01 mm
Over sampling with filtering, averaging techniques, etc. resulting in an overall throughput (analog signal to converted digital signal) from 0 Hz to 1200 Hz
Major and sub-calibration points that allows relative sensors to be used
Wireless and/or wired communication to other computers, pens, pen input devices 102 and miscellaneous devices 122 (e.g., cell phones). Security is provided with unique ID's and RSA encryption technologies (if required). Supports peer-to-peer interfacing.
Various memory sizes depending on number of written pages/forms 124. Note: 128 kbytes supports approximately 40 written (full) pages.
Multiple electronic stylus/ink pen/pencil/erasers/scanner configurations

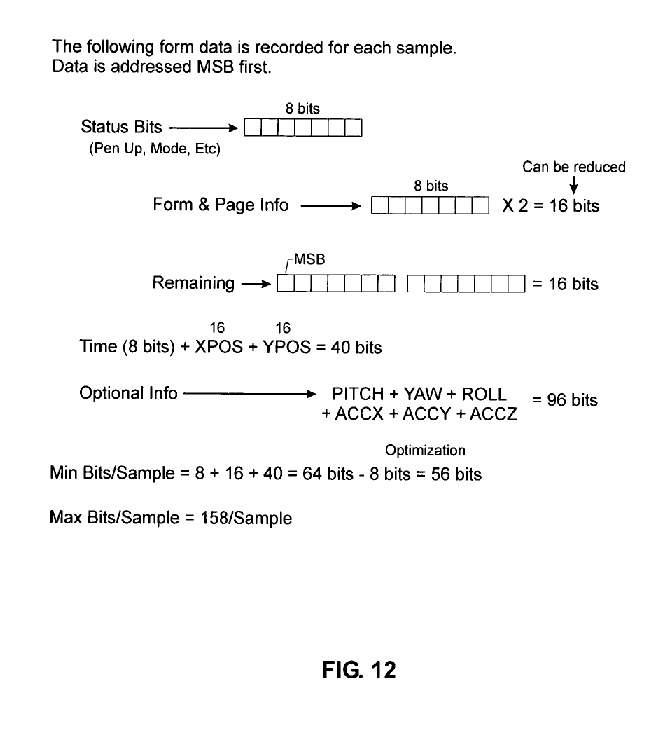

The main memory of the processor 150 is given address range 0FFFFh-01000h. The conuration file and program are stored in flash memory. The external memory 156 may be used for data. The data recorded for each sample is illustrated in FIG. 12.

FIG. 6B is an exemplary block diagram of the pen input device 102. The diagram differs from FIG. 6A in that a novel use of the memory 157 is shown. The implementation allows the memory 157 to be directly connected to the processor 150 or the computer system 104. Connection to the computer system 104 does not require the processor 150 to be active. This may be accomplished by a switching component 153, which may consist of various FETs configured. When a connector 159 is plugged in to the pen input device 102, the memory 157 is no longer connected to the processor 150. The connection 159 to the computer system 104 is accomplished via a connector 159 and cable to memory 157. The memory 157 may be a SanDisk transFlash memory card, for example a Model No. SDSDQ defining a memory card interface to the computer system 104. With such a configuration, when the connector 159 is disconnected from the pen input device 102, the memory 157 is then reconnected to the microprocessor 150. This novel approach allows the use of a memory card 157 that is embedded in the pen input device 102 which can interface directly with a computer 104. The approach may also be extended to other devices 122 (namely, cameras, mp3 players, phones, etc.

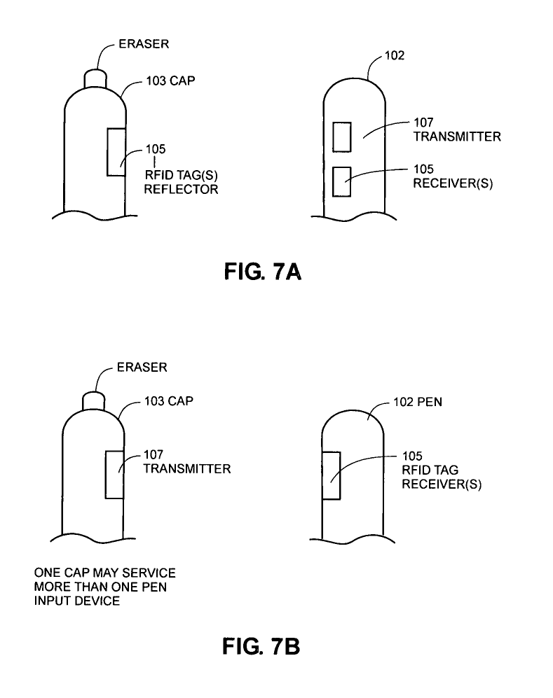

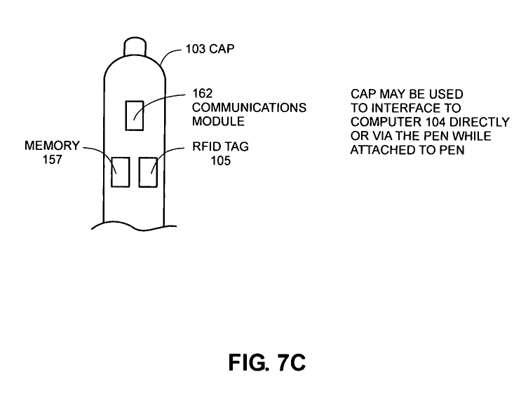

FIGS. 7A-7C illustrate various components that may be embedded in the pen input device 102 and/or cap 103, such as an RFID tags 105. Exemplary implementations are shown in FIGS. 7A-7B included in the configurations. One cap 103 may be used to connect several pen input devices 102 in a collaborative environment, i.e. writing on the same virtual space.

FIG. 8. illustrates various exemplary user interfaces for the pen input device 102. Referring to FIG. 8, the operation of the pen input device 102 is described in connection with a three pushbutton interface. However, other pen interfaces are also considered to be within the scope of the invention. As shown in FIG. 8, the system may include three or more pushbutton switches, for example, a first pushbutton PB1 that may be pressed to start writing on a new form page. A second pushbutton PB2 may be used when a new calibration is required. The third pushbutton PB3 may be toggled to turn the pen input device 102 on and off. A simple on/off limit switch 168 may be used to turn the pen input device 102 on/off. If the pen input device is equipped with an electronic stylus, the switch 168 may be used to indicate that the pen input device 102 electronics are off. When the pen input device 102 is in pen input mode, the limit switch 168 may be used to indicate that the pen input device 102 is on.

The initial configuration for the pen input device 102 is as follows:
unique ID for the pen input device 102 is set
unique ID for each device 102, 122, computer, pen input device, etc. that the pen input device 102 can communicate with over the pen peer-to-peer network is set
number of forms supported is set to 3, for example.
form type linked to form number forms 1 and 2 are blank forms 124 and form 3 is a function (email) form 124
form definition disabled
number of calibration points is set to 3
sensor update rate is set to 1800 Hz
form document collaboration is disabled
ADC algorithm is set to running average
roll compensation is enabled
x, y, and time position storing rate is set to 600 Hz
form data send enabled
form data received enabled
pen peer-to-peer network search enabled
exchange unique ID's with a pen peer-to-peer input device, computer/tablet pc, etc. is disabled
send/receive status information
eraser/highlighter/red-liner disabled
force sensor disabled

After the user toggles the pushbutton PB3 to turn the pen input device 102 on, the pen input device 102 loads the initial configuration (assuming the pen input device 102 and the electronic recording system 104 are connected) and defaults to a default form 122 and the calibration mode and the last form page used when using the pen input device 102.

Several implementations of the on/off function. For example, a simple on/off switch may be used to turn on the pen input device 102. The pen input device 102 may be configured so that the pen input device 102 is turned on when the barrel is twisted and enables the ink/pencil cartridge to protrude through the end of the pen input device

The pen input device 102 may be configured with multiple modes of operation. These modes may be selected by various mode selector switches/pushbuttons 168 (FIG. 8) and include: an on/off mode; a calibration mode; a write mode, an erase mode, a transmit or submit mode and a form calibration mode. As shown and discussed, a number of selector switches/pushbuttons 168 provide a user interface to the pen input device. The number of selector switches/pushbuttons 168 is merely exemplary. It should be understood that either individual pushbuttons can be provided for each mode or dual function pushbuttons can be used Such dual function pushbuttons are extremely well known in the art. Moreover other user interfaces are also possible, such as twist type switches

For example, the form calibration mode is selected by the user to create a new form with a pen input device. Once the form calibration mode is selected, the user can create fields or boxes in a field box mode and enter data in a stroke mode. The field box mode and the stroke mode may be selected by way of the selector switches/pushbuttons 168, which may be configured with dual functions. In particular, selector switches/pushbuttons 168 may be configured to enable selection of the on/off mode; the calibration mode; the write mode, the erase mode and the form calibration mode. However, once the form calibration mode is selected, two of the switches/pushbuttons 168 may be configured to be used for the field box mode and the stroke mode when the form calibration mode is selected.

As discussed above, in the calibration mode, three parameter points are required in order to calibrate the form 124 to the writing surface. As mentioned above, the pen input device 102 may initially default to the calibration mode after the pen input device is turned on. In a calibration mode, the user presses the pen input device on three points of the writing surface to initialize the major calibration points.

The pen input device 102 may be configured with various functions. These functions may include: new page selection; new form selection; re-using a form to collect raw data, calibration, form creation, merging form data, editing form data, such erasing, highlighting and red-lining, etc. These functions are described below.

First, a form 124 may be selected by way of a web application, discussed below, from a forms library stored on the computer system and transferred to one or more pen input devices 102 to link a virtual form 124 to a physical form. The form 124 may be selected by form meta data, as discussed above. Alternatively, as discussed below, the pen input device 102 may be used to create a new form. After the form 124 is linked to the physical form, the user may start writing. The user may start a NEW_PAGE by pressing one of the selector switches/pushbuttons 168 on the pen input device 102 to select a write mode. The user may upload pen data to the computer system 104, for example, by depressing one or more of the pushbuttons PB1, PB2 or PB3 after the connection is enabled. In the exemplary implementation, illustrated in FIG. 6B, the data may be transferred by way of the memory card 157. In web applications, as discussed below, the data from the pen input device 102 may be uploaded by way of a web host. After the pen input device 102 is connected to the electronic recording system 104, the user selects the a pushbutton 168 which causes form data to be transmitted to the electronic recording system 104 by way of the communication module 162 (FIG. 6A) and configures the system for A default form 124 and a first form page. For example, the pushbutton PB3 may be then toggled to turn off the pen input device 102. The current mode of the pen input device 102 is displayed on the display 170.

As mentioned above, the pen input device includes a user interface as illustrated in FIG. 8, which includes LEDs 164 for status indication. For example, three LED's 164 may be provided on the pen input device 102. The LED's 164 are all different colors. For descriptive purposes, the LED's are blue, green, and white. The following are the default settings of each LED 164.
The green LED 164 may be turned on when the pen input device 102 is on. The green LED 164 may flashes when the pen's memory is full. The green LED 164 stops flashing when the pen's memory is no longer full and then turn on again to indicate the pen input device 102 is ready for use. The “full” level can be set at different levels (e.g., % of total memory).
The blue LED 164 may flash when the pen input device 102 needs to be calibrated. The blue LED 164 may be solid when the pen input device 102 is sending/receiving information. The Blue LED 164 may be off when all the information is sent/received.
The white LED 164 may flash when information is being sent or received and stops flashing after the information have been sent/received. This verifies that the information is accepted.

### File Format

There are several file formats that can be used to communicate from application to application. As will be discussed in more detail below, the present invention is web based. In accordance with an important aspect of the invention as discussed below, the pen input device 102 is configured to provide data to an application running on a web browser in inkXML format. An exemplary format for the pen input device 102 for use with the present invention is the Ink Markup Language Draft, as set forth in the proposed inkXML standard, ”Ink Markup Language InkML, W3C Working Draft 23 Oct. 2006, available at http://www.w3.org/TR/InkML, hereby incorporated by reference. In its simplest form, an exemplary inkXML file with its enclosed traces is shown below:

<ink>

<trace>

10 0 9 14 8 28 7 42 6 56 6 70 8 84 8 98 8 112 9 126 10 140
13 154 14 168 17 182 18 188 23 174 30 160 38 147 49 135
58 124 72 121 77 135 80 149 82 163 84 177 87 191 93 205

</trace>
<trace>

130 155 144 159 158 160 170 154 179 143 179 129 166 125
152 128 140 136 131 149 126 163 124 177 128 190 137 200
150 208 163 210 178 208 192 201 205 192 214 180

</trace>
<trace>

227 50 226 64 225 78 227 92 228 106 228 120 229 134
230 148 234 162 235 176 238 190 241 204

</trace>
<trace>

282 45 281 59 284 73 285 87 287 101 288 115 290 129
291 143 294 157 294 171 294 185 296 199 300 213

</trace>
<trace>

366 130 359 143 354 157 349 171 352 185 359 197
371 204 385 205 398 202 408 191 413 177 413 163
405 150 392 143 378 141 365 150

</trace>

</ink>

These traces consist simply of alternating X and Y values.

The following named attributes are reserved. These attributes translate nicely for use with a pen input device 102. Extensions can be made within the XML standard to accommodate the pen input technology.

The following channel names, with their specified meanings, are reserved:

| channel | |
|---|---|
| name | interpretation |
| X | X coordinate (horizontal pen position) |
| Y | Y coordinate (vertical pen position) |
| Z | Z coordinate (height of pen above paper/digitizer) |
| F | pen tip force |
| S | tip switch state (touching/not touching the digitizer) |
| B1 . . . Bn | side button states |
| Tx | tilt along the x-axis |
| Ty | tilt along the y-axis |
| A | azimuth angle of the pen (yaw) |
| E | elevation angle of the pen (pitch) |
| R | rotation (rotation about pen axis-i.e., like the roll axis of an |
| | airplane) |
| T | time (of the sample point) |

Not all the above information need be used in a stylus/digitizer implementation. However, using the standard for the pen input device 102 technology enables a greater integration with various applications 120 and therefore increases the value-add in a business like implementation. As such, the file format is well grounded allowing the use a W3C standard as a baseline.

### Web Application

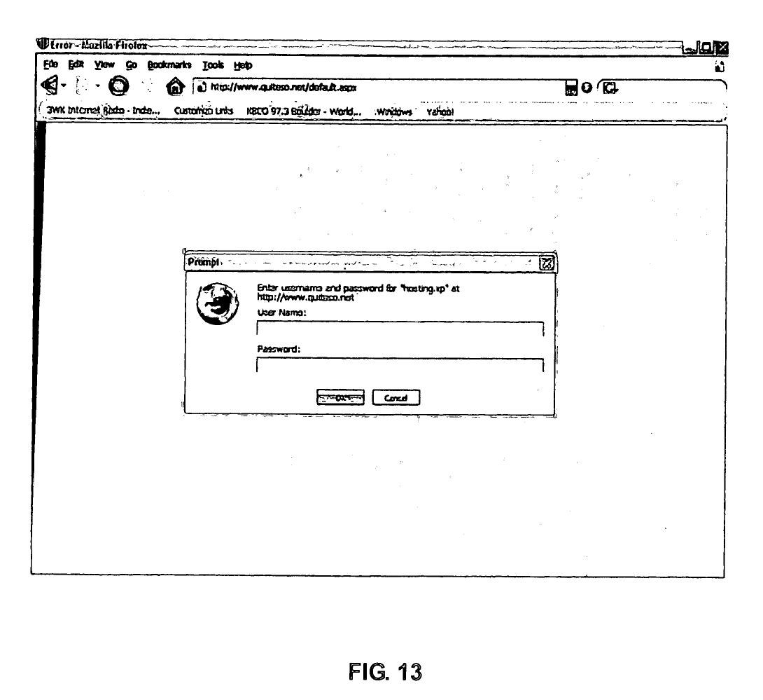

FIGS. 13-19 illustrate exemplary web pages for an optional web-based implementation of the present invention. A general description along with software flow diagrams of the web page operation is provided. The exemplary implementation may be done with different technologies (e.g., thick client with dll's, Java applets, .net, etc.). Many of the exemplary functions (e.g., 3^{rd} party functionality 112) are implemented by adding functionality via application's API's. The User Interfaces (UI) look and feel is simplified for illustrative purposes. Additional UI functions are described but not shown. Initially, a user launches a web browser and types the appropriate url to get to the log in page illustrated in FIG. 11.

### Upload Device Data

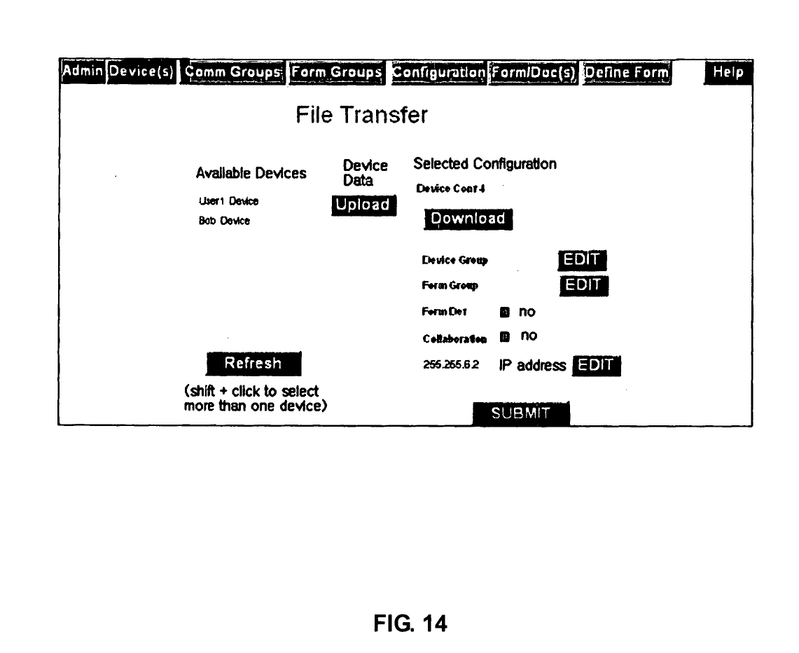

After the user successfully logs in, a File Transfer web page, as illustrated in FIG. 14, is launched. The File Transfer page indicates what pen input devices 102 are connected to the network in an “available devices list.” The list may be updated by clicking on a refresh button. The File Transfer page may be used to upload device data and also download configuration data to a pen input device 102. Also, the File Transfer page provides various information, such as device group, form group and IP addresses to be edited. After the edits are made, a Submit button is selected which causes the edits to be stored in the database 110.

To upload form data from the pen input device 102, the user simply:
selects the pen input device 102 from the device list
clicks on the upload device data button
The user is then prompted for the file storage location.

The conversion process may be automated by having a known directory. Alternatively, the url can be parsed and stored on the database 110. The user is able to copy or move files to the directory. The directory may be a web share directory. Once the file is placed in the directory, an application 108 may be launched to merge the file to a format that is accepted by various pen-enabled applications.

A configuration name is displayed when a user selects a pen input device 102. The user then has the following options:
click on the download button to send the configuration information to the selected pen input device 102
edit configuration information by selecting the edit buttons of clicking on the toggle button
save the configuration changes by pressing the submit button. The configuration name has not changed but the change would impact other pen input device 102 configurations.

### Creating/Changing a Form Group

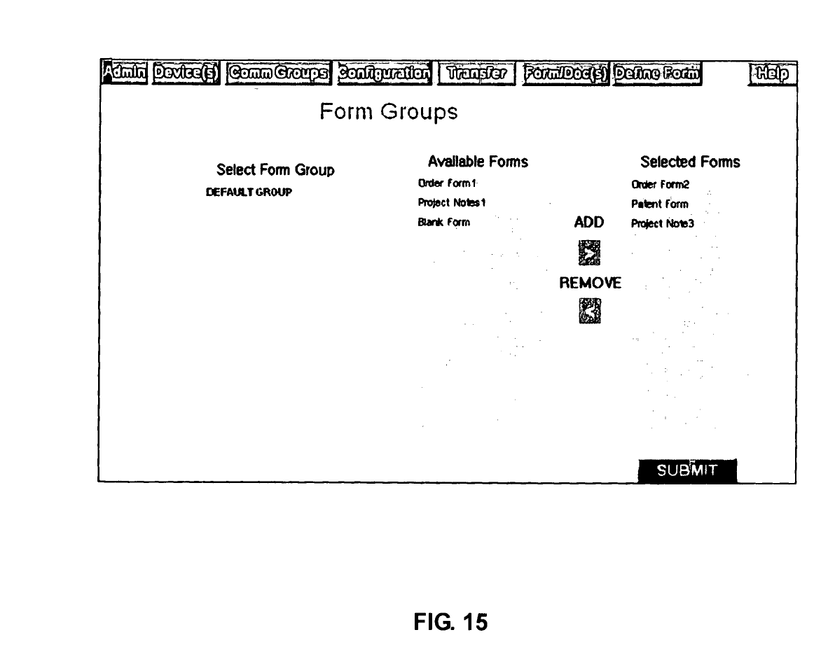

A Form Groups page, illustrated in FIG. 15, may be selected by selecting the Forms Group button on any other page. The Form Groups page is used to define a form group. A form group is a name given to a group of forms 124.

In order to create or change a form group, the user does the following:
select a form group from the drop-down menu or types in a new form group name.
forms 124 available/defined are listed as well as the current forms 124 that are associated with a form group.
forms 124 may be added or removed by selecting a form 124 and clicking on the add/remove button as needed.
The changes are saved when the user clicks on the submit button.

### Creating/Changing a Device Group

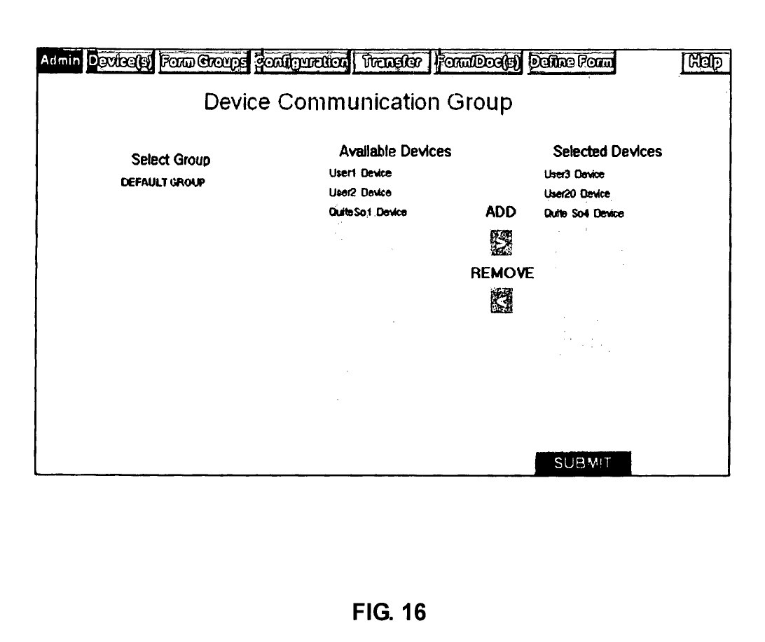

The Device Communication Group page is illustrated in FIG. 16. This page may be reached by selecting the Communication Groups navigation button on any other page. The main purpose of the Device Communications page is to define a communications group. A device communications group is a name given to a group of devices that can communicate with each other in order to create or change a device group, the user does the following:
select a device communications group from a drop-down menu or type in a new device group name.
the pen input devices 102 that are available are listed as well as the current pen input devices 102 that are associated with a device communications group.
pen input devices 102 may be added or removed by selecting a pen input device 102 and clicking on the add/remove button as needed.
the changes are saved when the user clicks on the submit button.

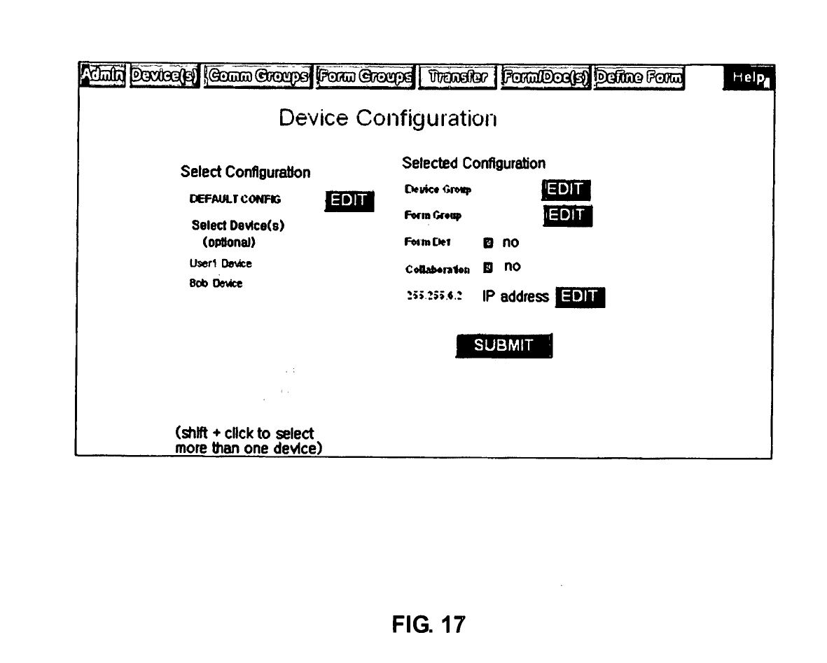

A Device Configuration page is illustrated in FIG. 17. The Device Configuration page may be reached by selecting a configuration button from another page. The main purpose of the Device Configuration page is to create or change the configuration and associate the configuration with a pen input device 102.

### Creating/Changing a Configuration Name

The configuration name is displayed when the user selects a pen input device 102. The user then has the following options:
edit configuration information by selecting the edit buttons or clicking on the toggle buttons.
if desired, select the pen input device 102 that is associated with a particular configuration.
save the configuration changes by pressing the submit button. The configuration name is changed if the change would not impact another pen input device 102.

### Enabling/Disabling Pen Input Devices

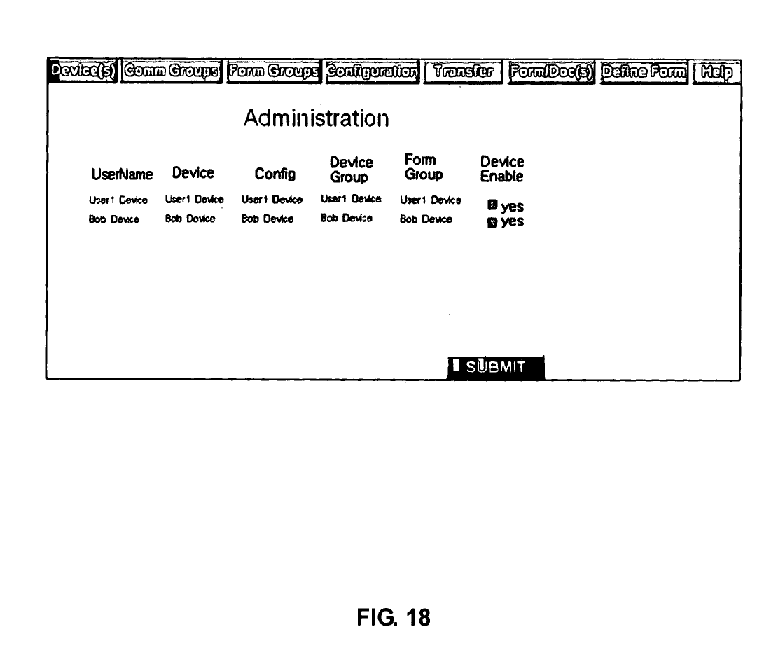

An administrative page is illustrated in FIG. 18. The administrative page may be reached by selecting the administrative button on any other page. The main purpose of the administration page is to enable a user to enable and disable pen input devices 102.

### Form Definition

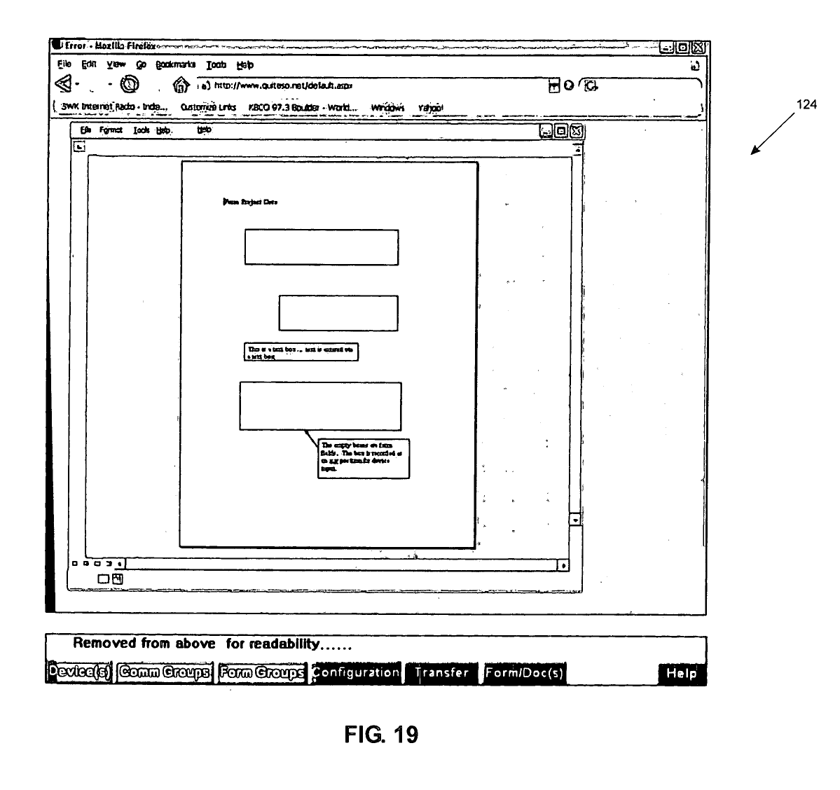

FIG. 19 illustrates a Form Definition page. The Form Definition page may be reached by selecting a form definition button on another web page. The main purpose of the form definition page is to create/or change a form 124. After the form 124 is defined and saved, it is given a form number. The fields are converted to x, y positions and stored in a database. A copy of the presentation is saved as well. Later, the form data may be mapped to each defined field and overlaid on top of the form 124 so that the user can view and modify all information on the form 124. Also, different field data from the form 124 may be provided to different applications.

### Network Configuration

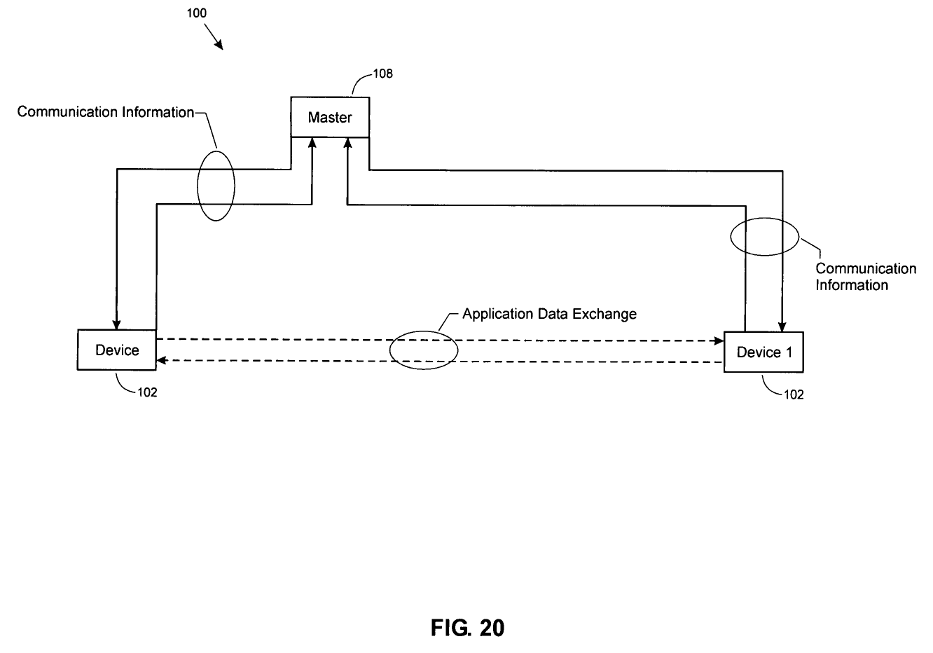

FIG. 20 is a configuration diagram of an exemplary network configuration for the computer system 100 in accordance with the present invention. The computer system is generally identified with the reference numeral 100 and includes a master 108 as well as two pen input devices 102. In this particular configuration, the master 108 has the following functions:
keep a list of pen input devices 102 and their respective IP addresses.
each pen input device 102 sends a “here I am” message to the master every x seconds, for example, one second. The pen input devices 102 send a url. The master 108 logs the pen input device 102 and IP address in order to keep the IP addresses current.
when a pen input device 102 wants to communicate with another device, the master 108 sends the necessary IP name combination to allow a connection.
each pen input device 102 has a list of pen input devices 102 and IP addresses to which it can communicate. This information (device names) is contained in the configuration file. Each pen input device 102 sends a “here I am” message to the master every x seconds. The pen input device 102 also sends a url to the master 108 along with its IP address and credentials.

When a pen input device 102 wants to talk to another pen input device 102, it sends the device name to the master 108. The master 108 sends back the device name and IP address. Each pen input device 102 will then have a direct connection with another one by way of the known IP address. The sending pen input device 102 sends its name and credentials to the receiving pen input device 102. The receiving pen input device 102 responds to the sending device 102 with its name and credentials. This establishes a communication handshake which allows the pen input devices 102 to communicate with each other. The sending device 102 queries the receiving device 102 to find out what functions it can provide.

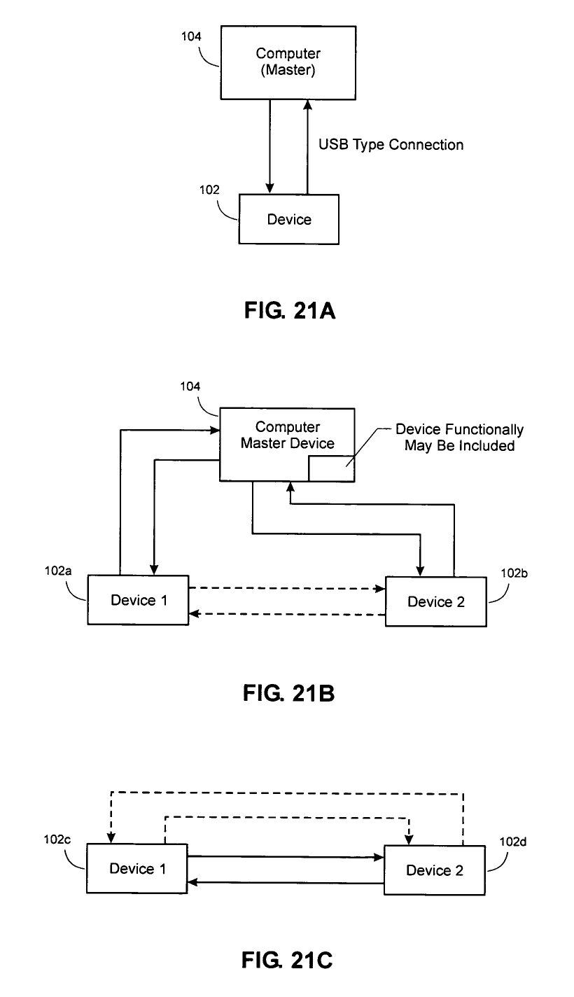

FIGS. 21A-21C illustrate various operating configurations for the pen input device 102 in accordance with the present invention. In particular, FIG. 21A illustrates a client/server configuration. In this configuration, a single pen input device 102 may be configured as a client to an electronic recording system 104 (FIG. 6A). As shown, the electronic recording system 104 and pen input device 102 are provided with bidirectional communication.

FIGS. 21B and 21C illustrate a configuration with multiple pen input devices 102. In FIG. 21B, the pen input device 102 maybe configured for centralized pen peer-to-peer operation. In this configuration, the computer system 104 acts as a master 108 and polls to find other to other pen input devices 102 available for communication and organize devices connection information. Once the master 108 has validated the various pen input devices 102 the master 108 advises the various pen input devices 102 that they have been validated and can now communicate with each other. The pen input devices 102 can then exchange communication independently of the master 108.

FIG. 21C is a diagram illustrating a decentralized pen peer-to-peer configuration in accordance with the present invention. In this configuration, the “masters” functions are distributed within each pen input device 102. Also a broadcast response may be used for pen input devices for communications sessions.

### Flow Diagrams

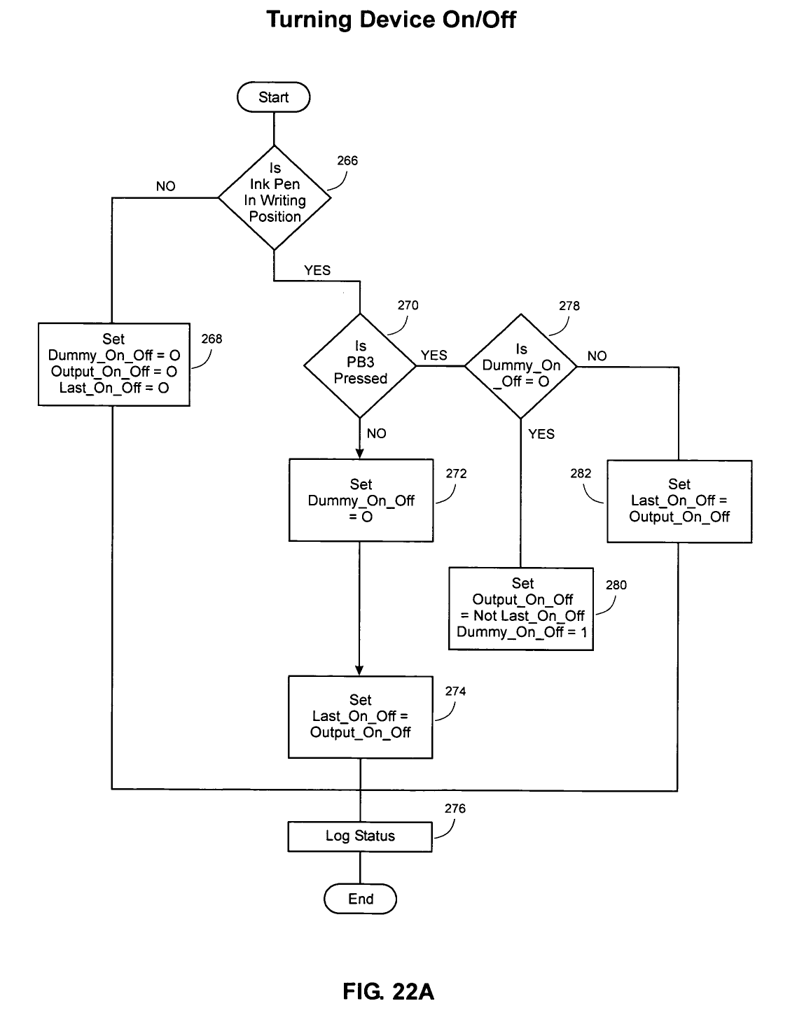

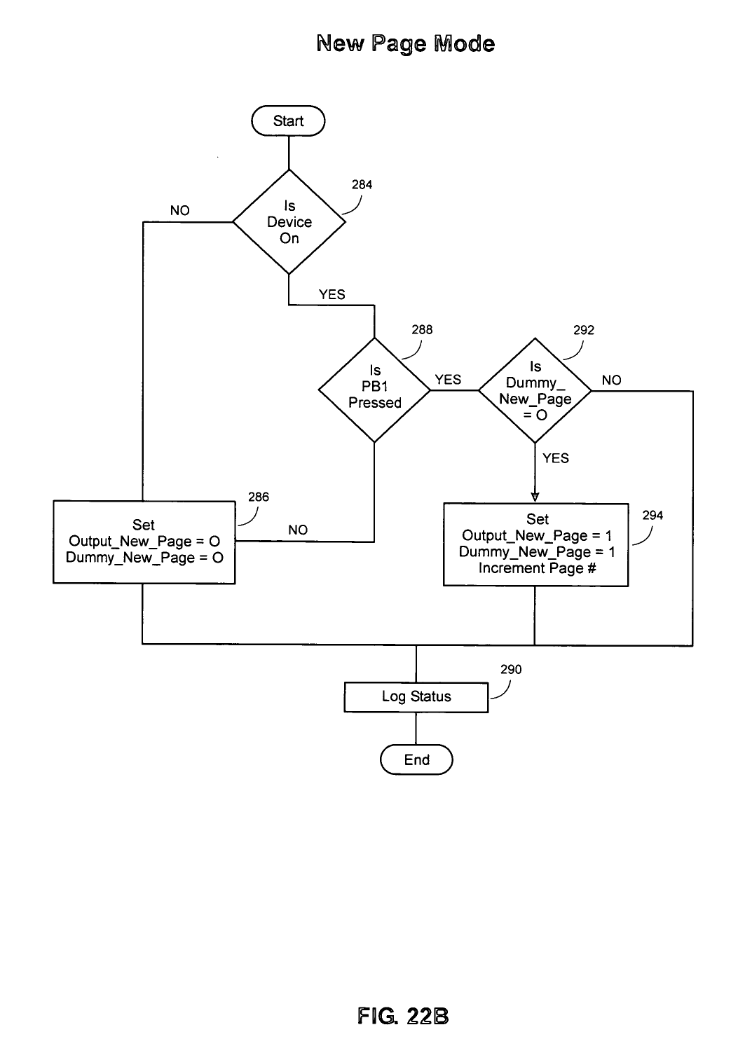

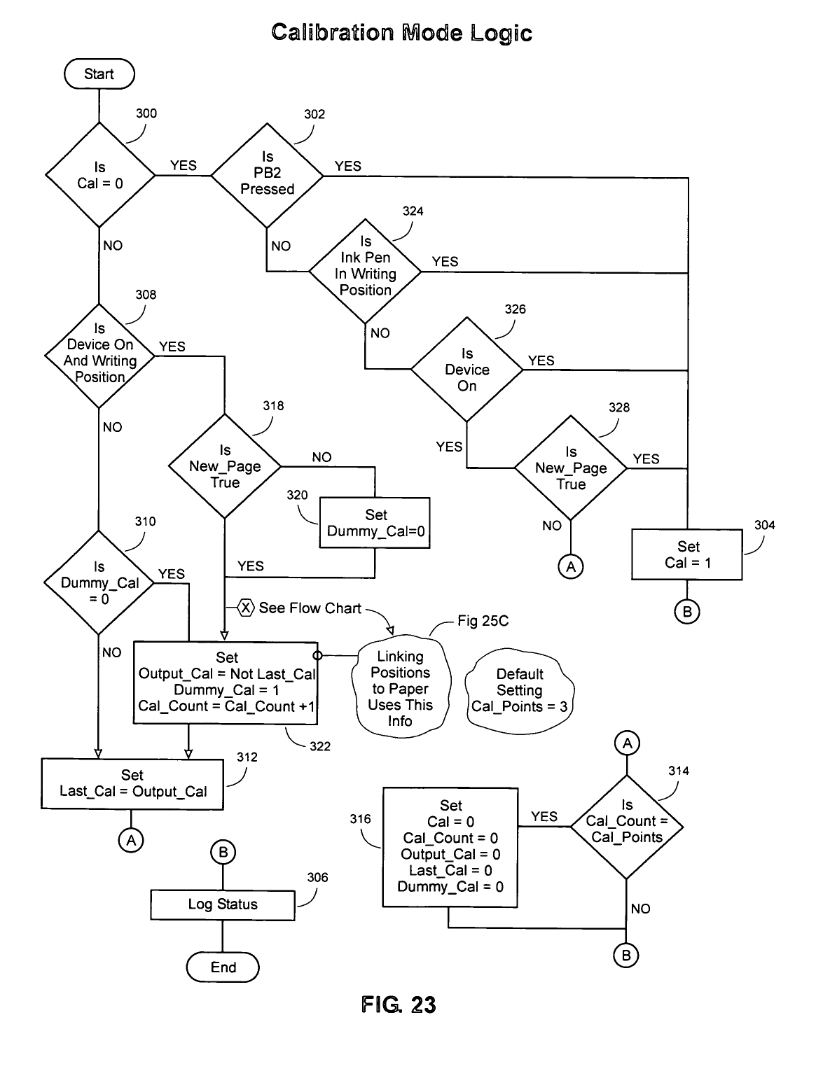

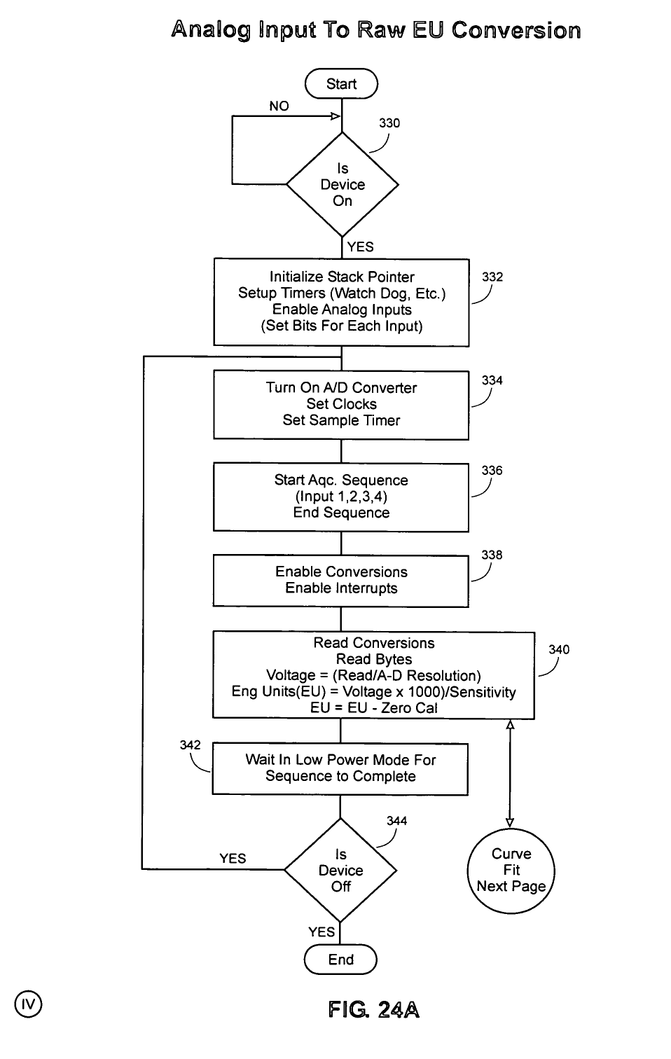

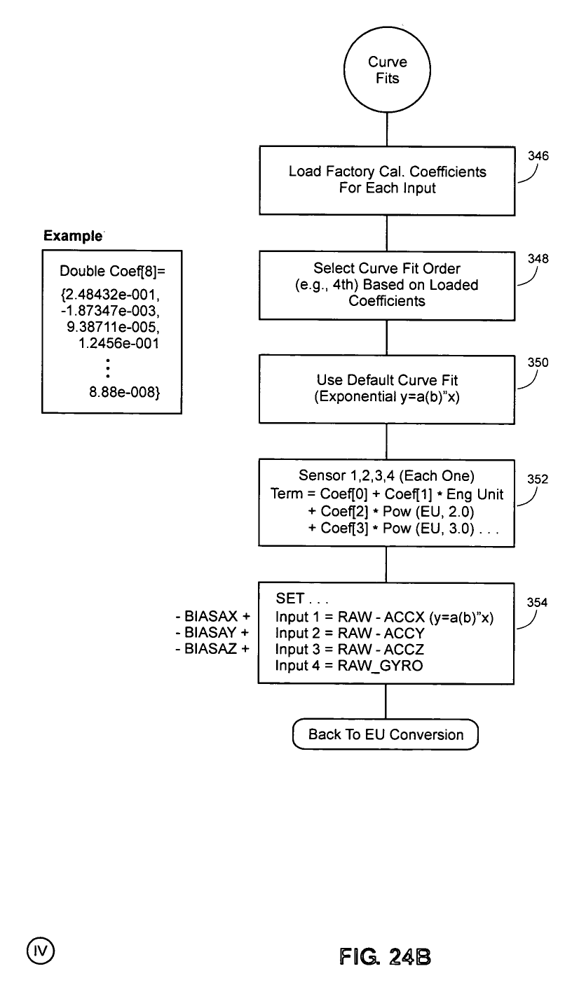

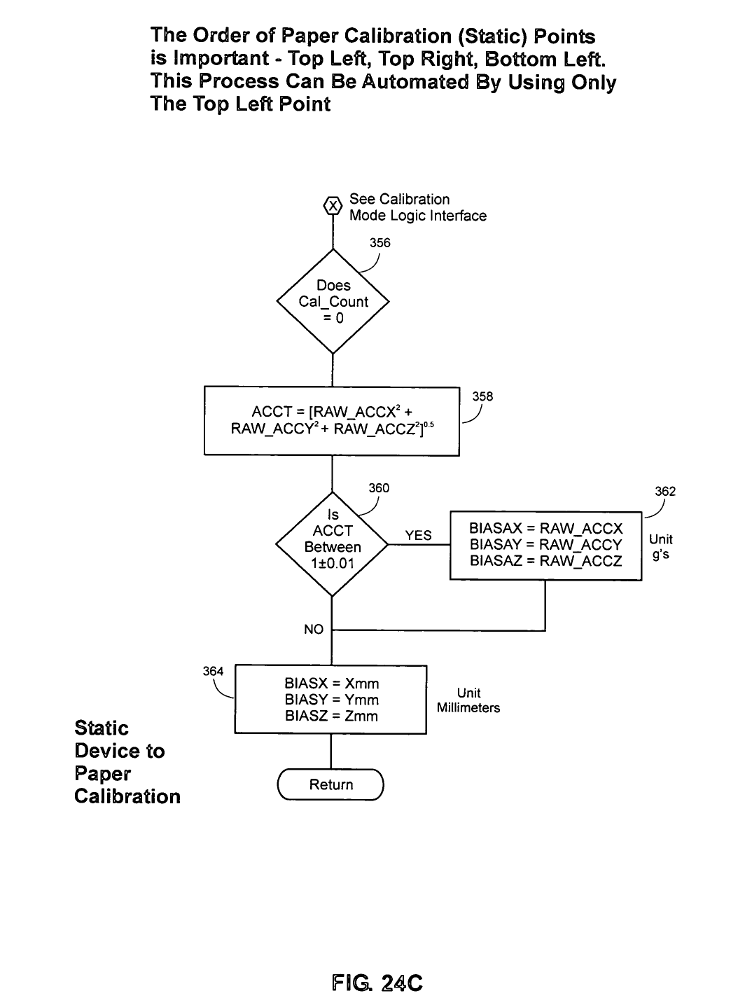

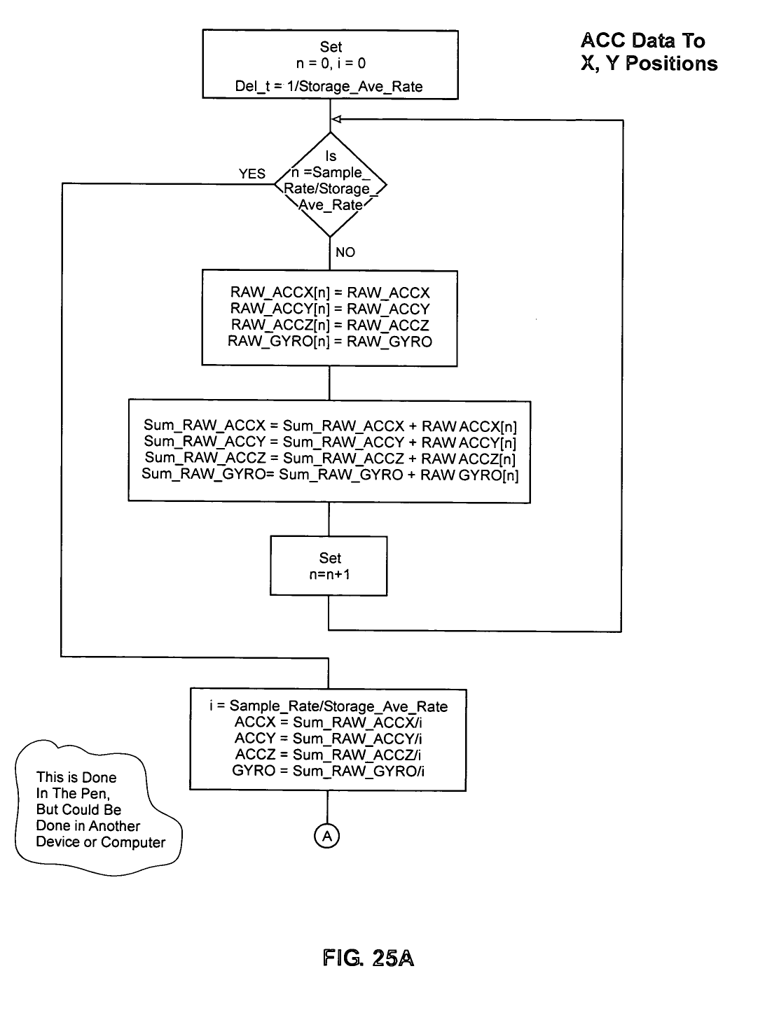

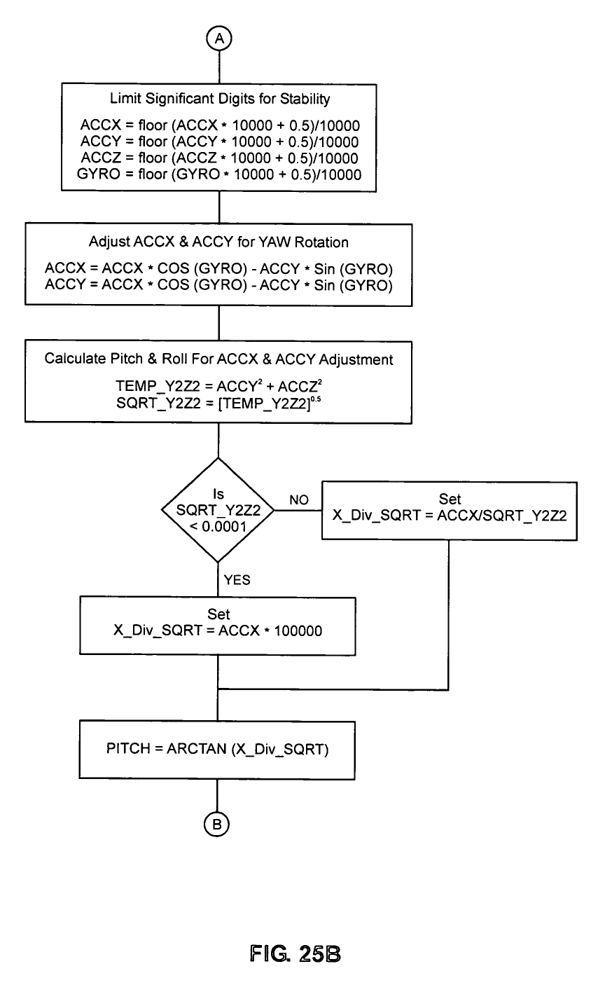

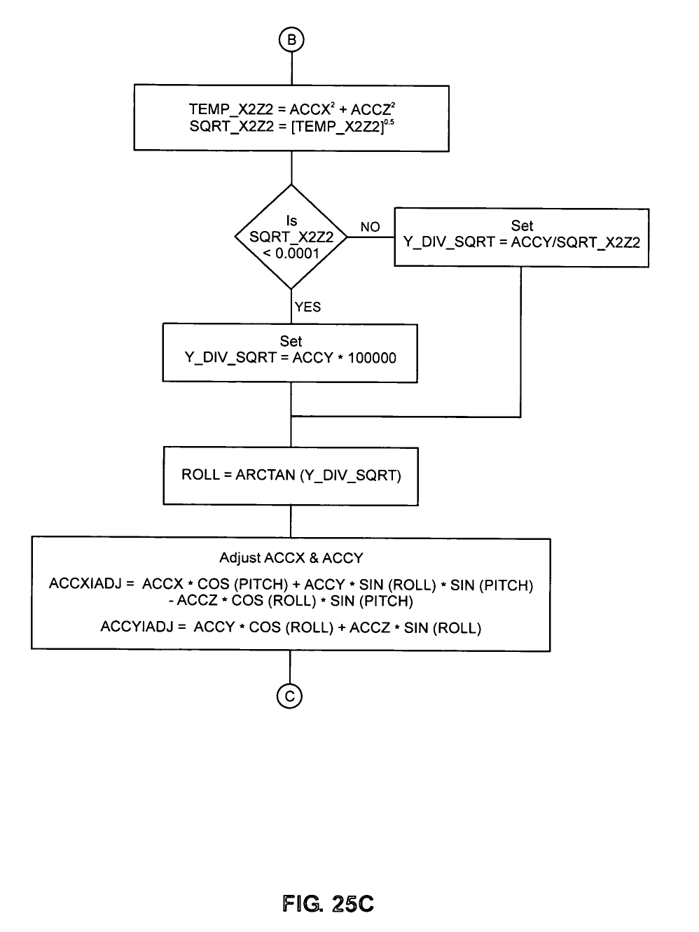

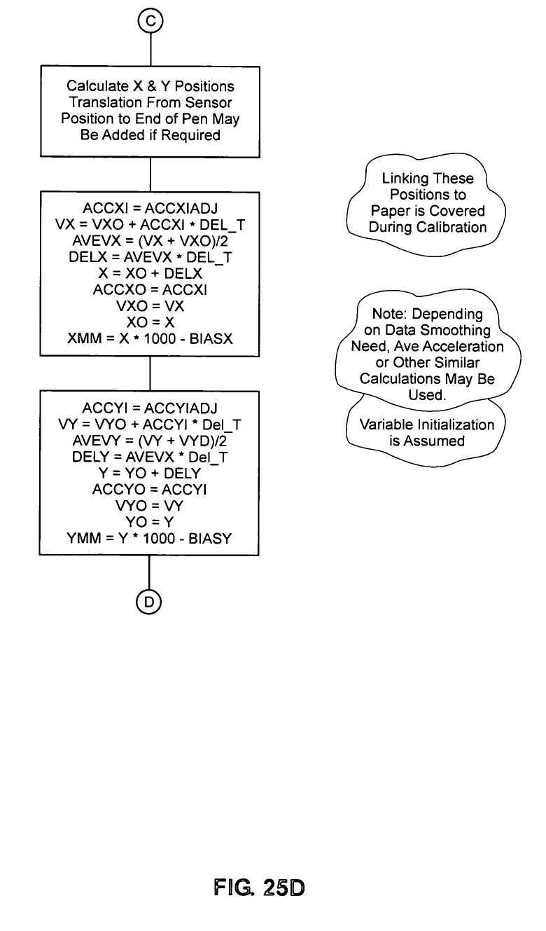

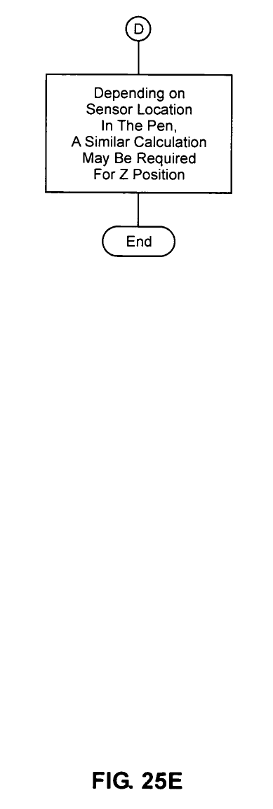

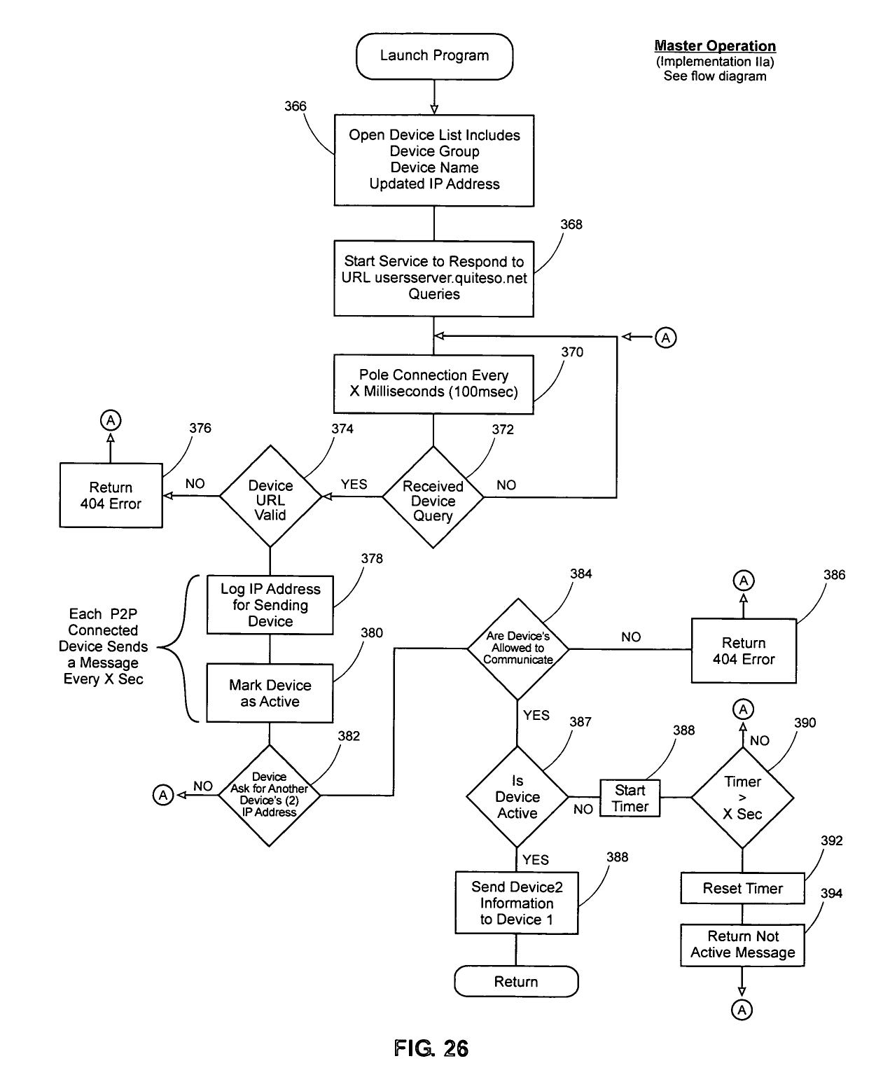

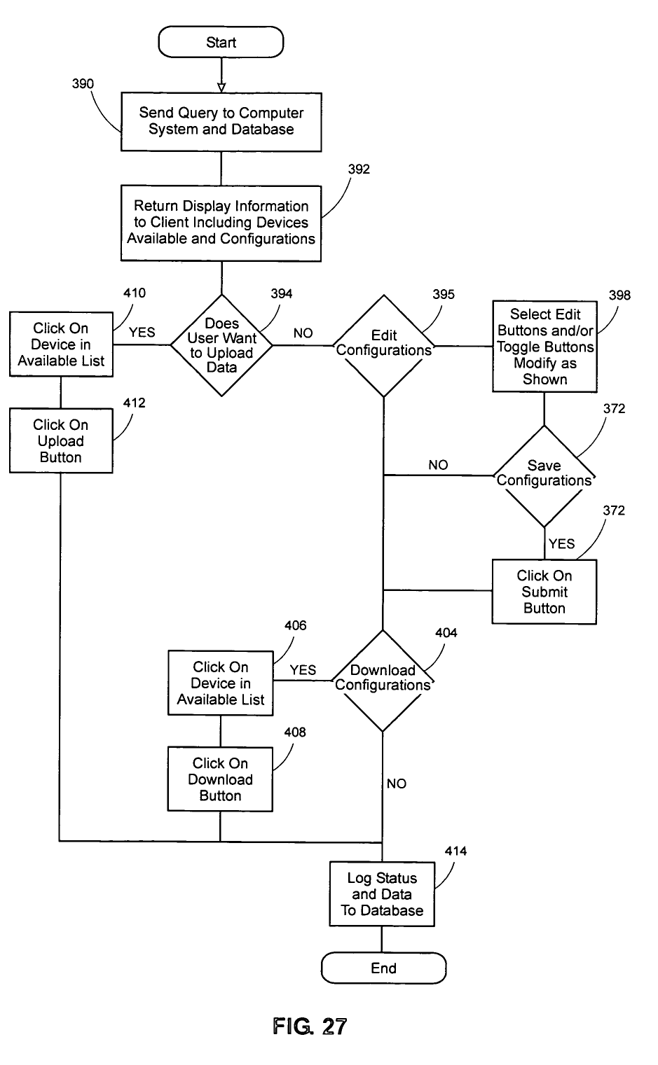

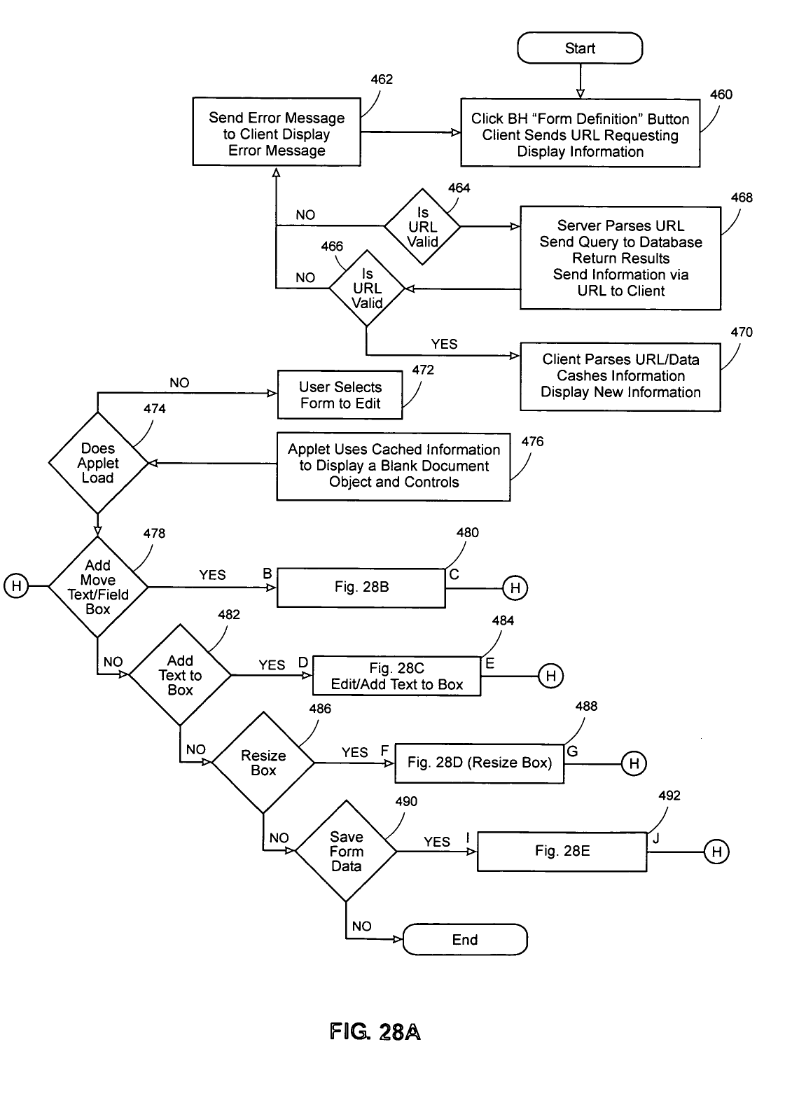

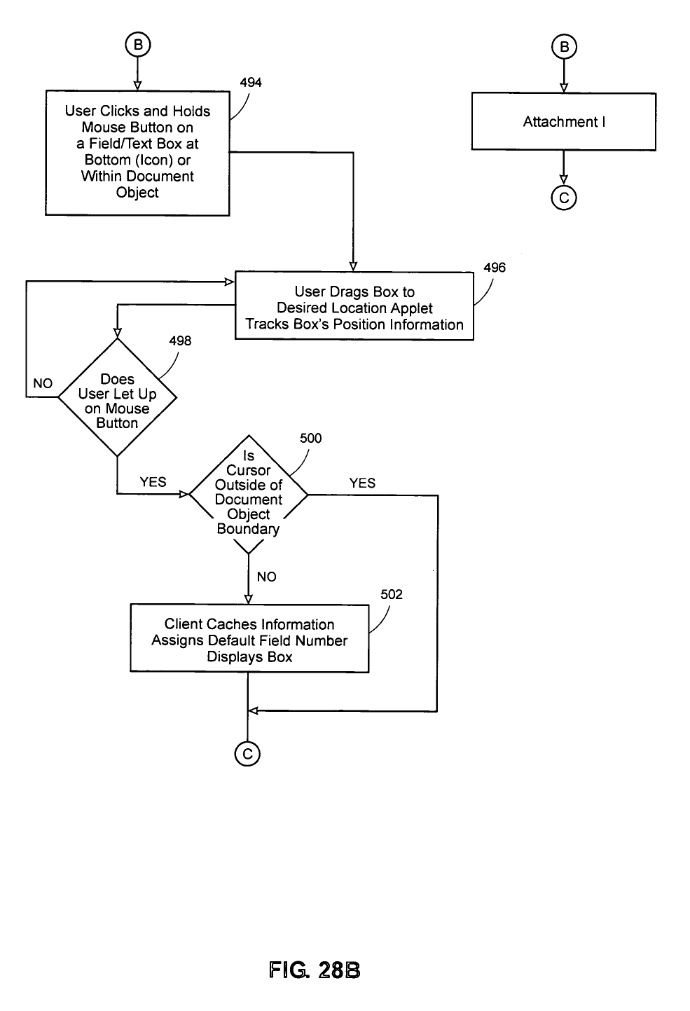

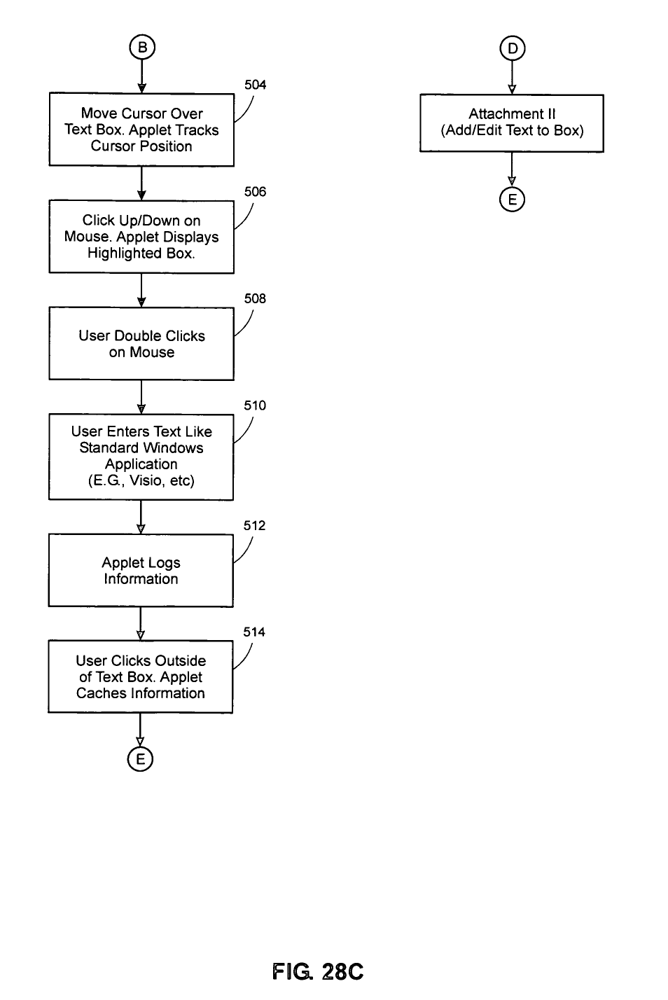

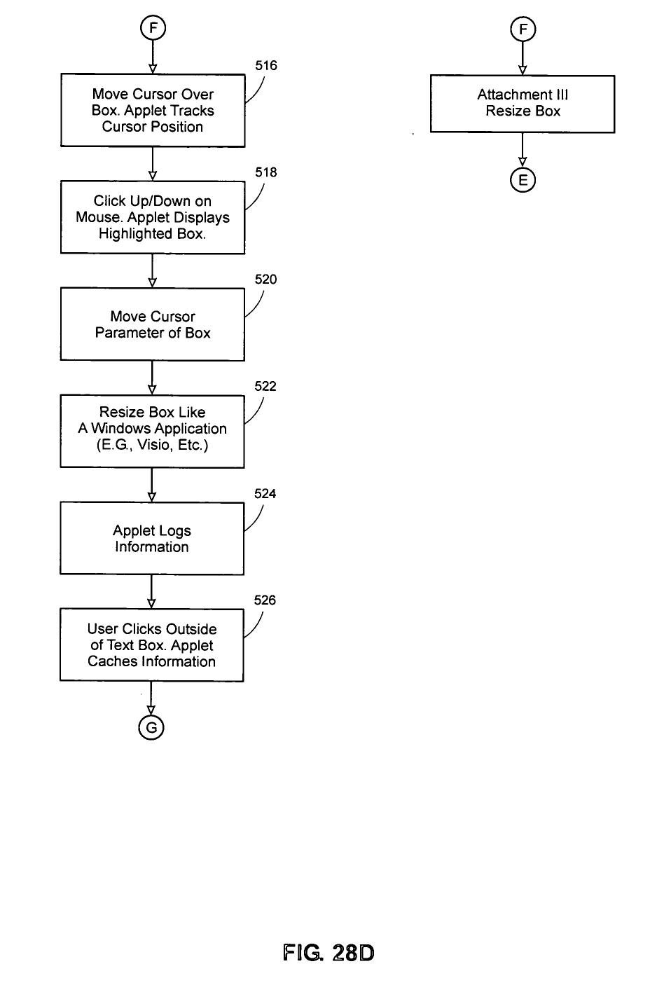

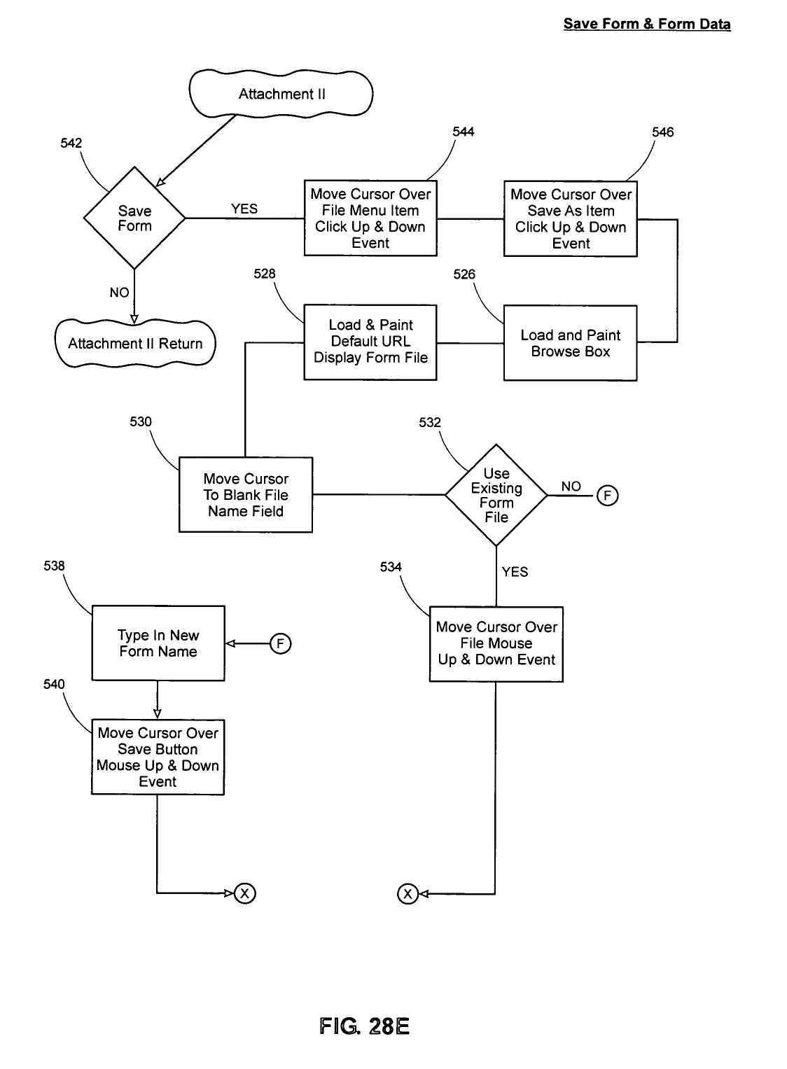

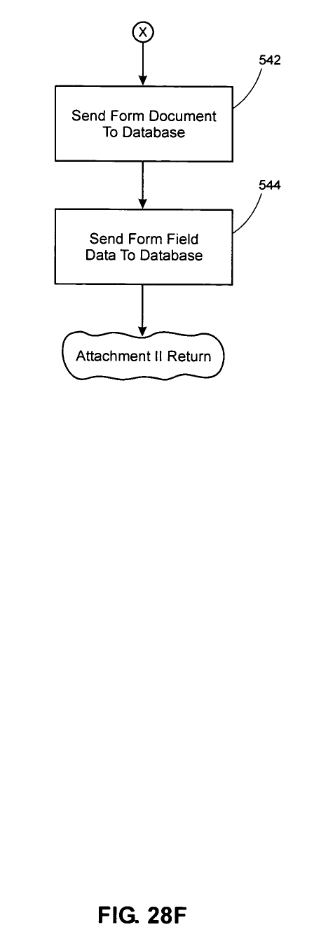

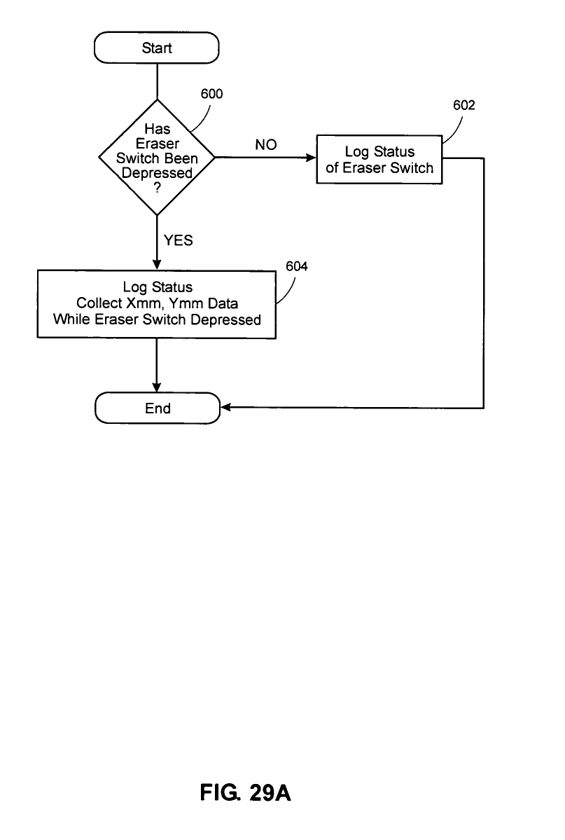

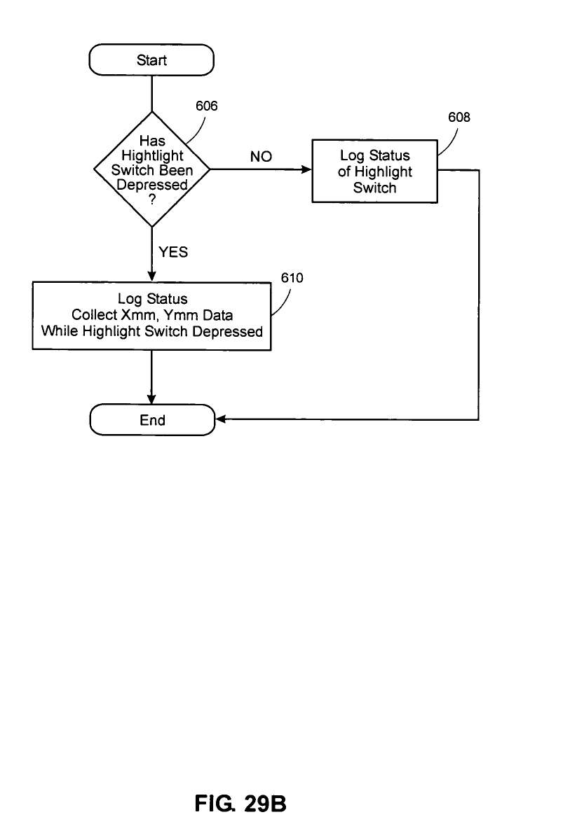

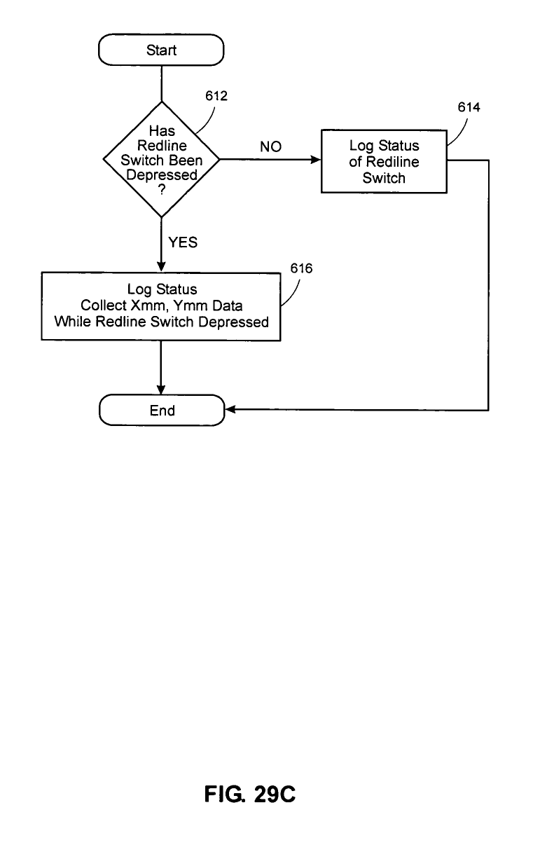

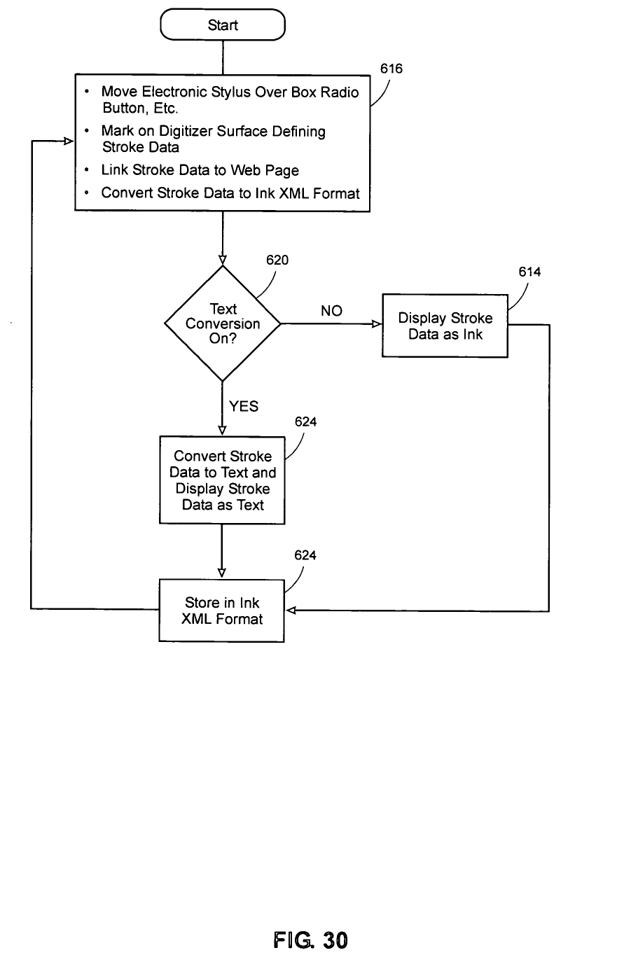

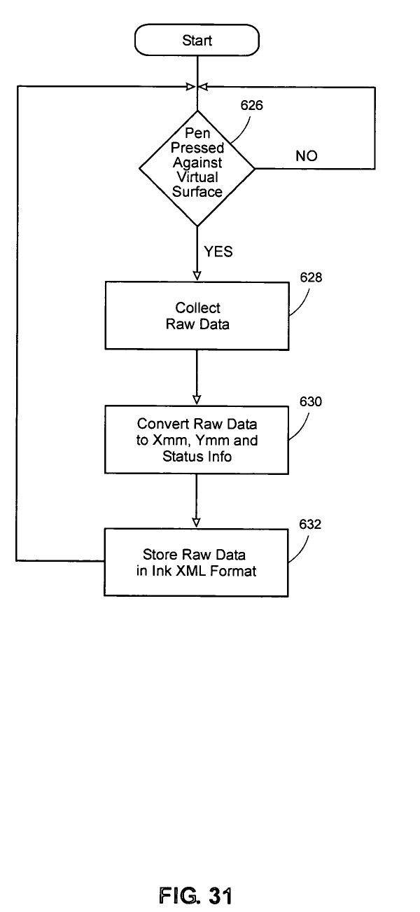

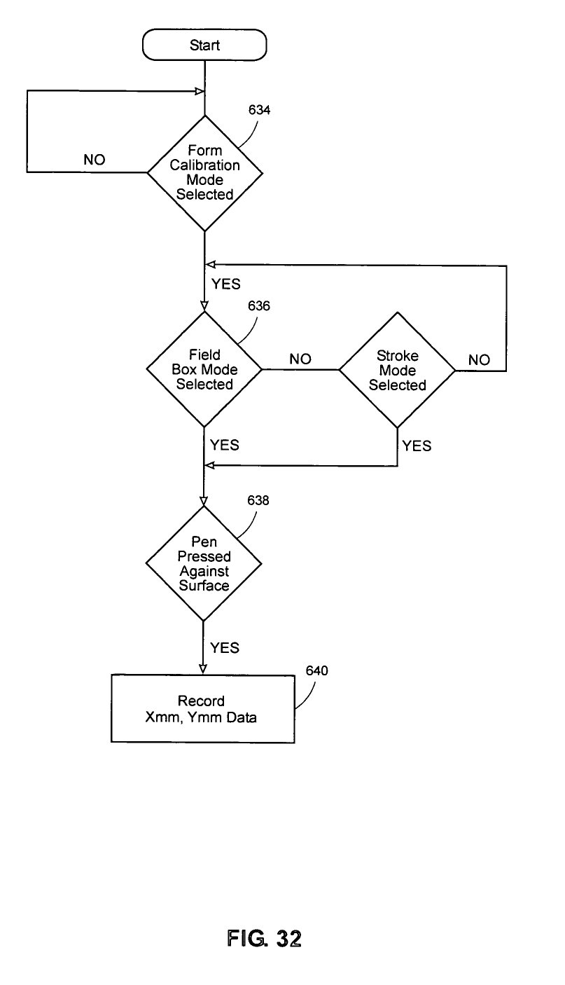

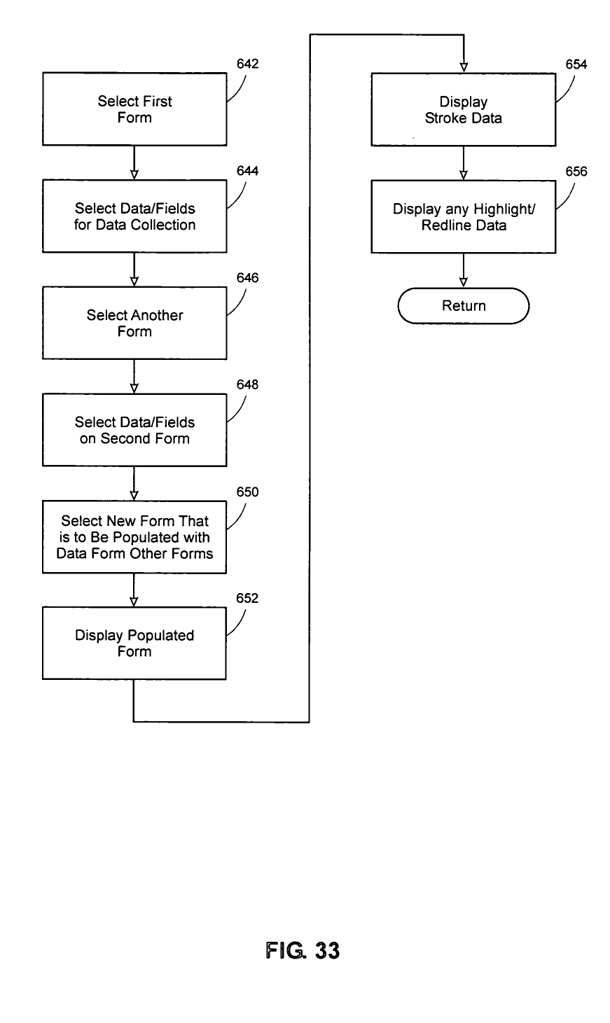

FIGS. 22A-28F are exemplary flow diagrams for the electronic recording system 104 and pen input device 102 in accordance with the present invention. The Form Definition flow diagrams, FIGS. 28A-28F, are shown in greater detailed than the other flow diagrams in order to illustrate a more detailed interaction between the various electronic recording system 104 components, such as the database 110. The remaining flow diagrams show the intended functionality at a higher level with the understanding of the more detailed interactions shown in the Form Definition Flow Diagrams FIGS. 28A-28F. In particular, FIG. 26 represents a software flow diagram for a pen input device 102 configured for pen peer-to-peer operation. FIG. 22A illustrates the basic ON/OFF operation of the pen input device 102. FIG. 22B is a software flow diagram for a pen input device 102, which illustrates the NEW_PAGE mode operation. FIG. 23 is a software flow diagram for a pen input device 102, which illustrates the calibration mode logic. FIGS. 24A-24C are software flow diagrams for a pen input device 102, which illustrates the conversion of the analog. input data to digital data. FIGS. 25A-25E are software flow diagrams which illustrate the conversion of raw accelerometer data to X, Y position data. FIG. 27 is a software flow diagram of a file transfer function which forms part of the web application. FIGS. 28A-28F illustrate software flow diagrams for a forms definition web application. FIG. 29A is a software flow diagram illustrating the erase function. FIG. 29B is a software flow diagram illustrating the highlight function. FIG. 29C is a software flow diagram illustrating the red-line function. FIG. 30 is an exemplary software flow diagram illustrating inking application by an electronic stylus on a tablet PC operating in a browser application. FIG. 31 is an exemplary software flow diagram illustrating an inking application for a pen input device in accordance with the present invention. FIG. 32 is an exemplary software flow diagram illustrating the creation of a form by a pen input device. FIG. 33 is an exemplary flow diagram illustrating merging of form data from different forms by a pen input device.

### Pen Network Operation

FIG. 26 represents a software flow diagram for a pen input device 102 configured for centralized pen peer-to-peer operation. The software for pen peer-to-peer operation is resident on the pen input device 102. In step 366, the master 108 opens the necessary device information to communicate with the various pen input devices 102. As illustrated FIG. 21B, “Device 1” is the sending pen input device 102 and “Device 2” is the receiving pen input device 102. In step 368 the electronic recording system 104 service is started to respond to the urls sent from the pen input device 102. The pen input device 102 poles the connection x milliseconds in step 370 to see if the query is received, as determined in step 372. If not, the polling continues and the system returns to step 370. Once the connection is made, the url is validated in step 374. If the url is determined to be invalid in step 374, an error 376 message is sent and processing continues at step 370. If the url is validated in step 374, the IP address for the sending device is logged in step 380 and the device is marked as active (i.e. connected to the network) in step 382. In step 382, the pen input device 102 asks the other pen input device 102 to validate IP addresses. If the IP address is not valid, control returns to step 370. If the IP address is valid, the pen input devices 102 is allowed to communicate, as indicated in step 384. If it is determined that the pen input device 102 can communicate, the system checks whether the pen input device 102 is active in step 387. If the pen input device 102 is active, it sends information to the other pen input device 102 in step 388. If the pen input device 102 is not active, a timer is started in step 388. In step 390, the system checks to see if timer has expired. If the timer has not expired, the system returns to step 370. If the timer has expired, the timer is reset in step 392 and a “Not Active” message is returned in step 394.

### Basic Pen Functionality

Turning to FIG. 22A, the on/off functionality of a pen input device 102 is illustrated. Initially, in step 266, the system determines whether the pen is in a writing position. This is done by checking the inputs from the tri-axial accelerometers. If the system determines that the pen input device 102 is not in a writing position, various variables, such as DUMMY_ON_OFF; OUTPUT_ON_OFF and LAST_ON_OFF are set to zero in step 268. If the pen input device is determined to be in the proper writing position, the system determines in step 270 whether the on/off pushbutton (e.g., PB3 has been depressed. If not, the system sets the variable DUMMY_ON_OFF equal to zero in step 272. In step 274, the variable LAST_ON_OFF is set equal to the variable OUTPUT_ON_OFF in step 274. The status is logged in 276.

If the system determines in step 270 that the on/off pushbutton PB3 has been depressed, the system checks in step 278 whether the variable DUMMY_ON_OFF is zero. The variable DUMMY_ON_OFF is zero, indicating that the on/off pushbutton PB3 has been depressed in step 278. If so, the system sets the variable OUTPUT_ON_OFF equal to the variable LAST_ON_OFF and DUMMY_ON_OFF equal to one. If the system determines in step 278 that the variable DUMMY_ON_OFF is not equal to zero, the variable LAST_ON_OFF is set equal to OUTPUT_ON_OFF in step 282.

The variables are defined as follows:
DUMMY_ON_OFF is an internal status flag used to process the logic.
OUTPUT_ON_OFF is a final variable indicating on off status of the pen
LAST_ON_OFF . . . internal variable indicating the previous state of the on/off bit. Use to toggle the OUTPUT_ON_OFF variable

### New Page Mode

FIG. 22B is a 102 software flow diagram illustrating the NEW_PAGE mode functionality of the pen input device 102. FIG. 22B shows an increment for each new page. The exemplary invention also includes a decrement function, that is similar. In step 284, the system determines whether the pen input device 102 is on. If not, the system sets the variables OUTPUT_NEW_PAGE and DUMMY_NEW_PAGE equal to zero in step 286. Step 290 logs status and returns from the process. If the system is on, the system checks in step 288 whether one or more of the pushbuttons 168 have been depressed. If not, the system returns to step 286 and logs the status in step 290. If the page mode pushbutton PB1 has been depressed, the system checks in step 292 whether the variable DUMMY_NEW_PAGE is equal to zero. If not, the system returns to step 290. If so, the system sets the variables OUTPUT_NEW_PAGE and DUMMY_NEW_PAGE equal to one and increments the page number in step 294.

The variables are defined as follows:
DUMMY_NEW_PAGE is an internal status flag used to process the logic
OUTPUT_NEW_PAGE is a final variable indicating NEW PAGE status of the pen input device 102
INCREMENT PAGE # is a variable indicating increment of form page number

### Calibration Mode Logic

The calibration mode logic for the pen input device 102 is illustrated in FIG. 23. Initially, the system checks in step 300 whether the variable CAL equals zero to insure that calibration mode is selected based on a change in mode. (e.g., New_Page or after the user has taken the pen input device 102 away from the working space for a while). Then the system checks the negative logic (i.e., no result) in steps 302, 324, 326, and 328. If any of these decisions are no, the system checks in step 316 if the variable CAL_COUNT is equal to CAL_POINTS. (i.e., the number of calibration points related to the writing surface.) If yes, as determined in step 314, the variables CAL, CAL_COUNT, OUTPUT_CAL, LAST_CAL, and DUMMY_CAL are set to zero in step 316. If the variable CAL is equal to zero, as determined in step 300, the system checks the positive logic (i.e., yes result of 302, 324, 326, and 328. If all of these steps are yes, then CAL is set to one and process A is executed. Then step 306 logs status and returns from the program.

Any time the variable CAL is not set to zero, the system checks in step 308 whether the pen input device 102 is in a writing position. If not, the system then checks to determine whether the variable DUMMY_CAL has been set to zero in step 310. If not, the variable LAST_CAL is set equal to the variable OUTPUT_CAL in step 312. Then process A is executed, step 306 logs status and returns from the program. If step 310 is yes, OUTPUT_CAL is step to opposite of LAST_CAL, DUMMY_CAL is set to one, and the CAL_COUNT is incremented by one 322. Next step 321 sets LAST_CAL equal to OUTPUT_CAL, process A is executed, step 306 logs status and returns from the program.

If the system determines in step 308 that the pen input device 102 is in the writing position, the system checks in step 318 to see if NEW_PAGE mode has been selected, as discussed above. If so, control proceeds FIG. 24C and performs the pen calibration logic. If not, the variable DUMMY_CAL is set to zero before proceeding to FIG. 24C. After the pen calibration logic set forth in FIG. 24C is executed, as determined in step 322, the variable OUTPUT_CAL is set opposite of LAST_CAL; DUMMY_CAL is set to one, and the variable CAL_COUNT is incremented by one. Then, in step 312, the variable LAST_CAL is set to OUTPUT_CAL. Next, the system checks whether the variable Cal_Count=Cal_Points in step 314. IF so the variables Cal; Cal_Count, Output_Cal, Last_Cal and Dummy_Cal are all set to =0 in step 316. The system then logs the status in step 306 and returns. If the variable Cal_Count≈Cal_Points, the status is logged in step 306 and the system returns.

The variables are defined as follows:
CAL indicates if the pen input device 102 is in calibration mode
PB2 is a calibration pushbutton
NEW_PAGE indicates if the current page is a NEW_PAGE
DUMMY_CAL is an internal status flag indicating if the pen input device 102 is still in calibration mode
OUTPUT_CAL indicates calibration status of the logic
DUMMY_CAL is an internal variable used to process the logic
CAL_COUNT indicates the current number of calibration points that the pen input device 102 is collecting
LAST _CAL indicates the previous state of the cal flag
CAL_POINTS is the total number of calibration points
ACCT is the root sum square of the overall acceleration value. A value of ˜1 means the pen input device 102 is not moving
biasax, biasax, baisaz . . . rezero difference between at rest value and recorded value
xmm,ymm,zmm engineering units in millimeters

### Conversion of Raw Analog Data

FIGS. 24A-24C represents software flow diagrams for converting analog input data to digital data. In step 330, the system checks whether the pen input device 102 is on. If not, the system loops and continues to check for turn-on of the pen input device 102. Once the pen input device 102 is turned on, the system is initialized in step 332 by initializing the stack pointer as well as various set up timers including the watch dog timer and the system variables. Next in step 334, the system turns on the analog-to-digital converter, sets various clocks as well as the sample timer. In step 336, the system starts the conversion sequence for the various inputs. Each pen input device 102 includes a tri-axial accelerometer as well as other sensors, force/position switch and a gyroscope which generate analog signals which need to be converted to digital signals. Note: this exemplary implementation may not be used for a beacon configuration. In step 336, the sequences of these various analog inputs are set while conversions and interrupts are enabled in step 338.

Conversions are initiated in steps 340 in a conventional manner (see FIG. 24B). FIG. 25B shows a typical curve fit algorithm used in a pen input device 102—an enhancement to current technology in pen input like devices 102. The system may sit in a low-powered mode until the sequence is complete in step 342. At the end of each, data collection cycle, the system checks whether the pen input devices 102 on or off in step 344. As long as the pen input device 102 is on, the system loops back to step 334 and converts additional analog signals from the various sources discussed above.

The software flow diagram illustrated in FIG. 24B is used for curve fitting. Initially, the system loads the factory calibration coefficients for each input in step 346. After the calibration coefficients have been loaded, the curve fit order is selected based on the loaded coefficients in step 348. Alternatively, in step 350, a default curve fit may be used. For each of the analog input sources, the digital values are determined in step 352. In step 354 the accelerometer X, Y and Z inputs are set equal to the variables input one, input two, input three along with a negative bias. The analog value from the gyroscope is set equal to input four.

FIG. 24C illustrates a software flow diagram for calibrating the pen input device 102 to a virtual writing surface. The order of static paper calibration points is important to be from top left to top right to bottom left. The process starts at the top left point. In step 356, the system checks whether the variable CAL_COUNT has been set to zero. No means that calibration mode is not active. If yes, the calibration mode is active. If yes, the system calculates the accelerometer tolerance in step 358 by taking the square root of the sum of the square of the raw accelerometer output values raw_accx; raw_accy and raw_accz. If within the tolerance 360, the pen input device 102 is not moving. If the accelerometer tolerance is between one plus or minus zero point one, the system sets the biases for the X, Y and Z accelerometers equal to the raw accelerometer values raw_accx; raw_accy and raw_accz. In step 362 if the tolerance of the accelerometers is not between the value, the bias for the triaxial accelerometers, bias X, bias Y and bias Z left to a predetermined millimeter value in step 364.

The variables are defined as follows:
voltage is the analog voltage of the raw sensor signal (x acceleration)
A/D resolution is the number of bits of the analog to digital convert (12 bits)
sensitivity is the micro volts per count that the pen input device 102 provides
Zerocal is when the sensor is at reset the value of the reading . . . .
coef[ ] is the standard curve fit calibration constants provided by the factory for each sensor
y is an adjusted engineering unit value
n is an polynomial degree
term is the total calibration value
biasx,biasy,bias z . . . zero recal value
input1, input2, input3 are the above term values
raw_accx,raw_accy,raw_accz,raw_gyro are the compensated engineering unit values

### Conversion of Accelerometer Data

FIGS. 25A-25E are flow diagrams for converting the raw accelerometer data from the triaxial accelerometers to X, Y, Z position data. These calculations are based upon the equations discussed above and thus are not described in detail since they are within standard practice. The variables are defined as follows:
del_t . . . time between data samples
storage_ave_rate . . . rate at which the pen input device 102 stores position data
sample_rate . . . rate at which the pen input device 102 samples the analog values
raw_accx[n],raw_accy[n],raw_accz[n],raw_gyro[n] . . . raw value stored in an array
sum_raw_accx, sum_raw_accy, sum_raw₁₃ accz, sum_raw_gyro . . . summary of the raw_xxx[n] values
n,i . . . internal integer value
accx, accy,accz,gyro . . . average engineering unit values
floor( ) . . . round off value to significant values
cos,sin,arctan, standard trig functions
temp_y2z2 . . . sqrt_y2z2 . . . y_div_sqrt . . . internal calculation values
temp_x2z2 . . . sqrt_x2z2 . . . x_div_sqrt . . . internal calculation values
pitch . . . Euler rotation angle
yaw . . . Euler rotation angle
accxiadj . . . adjusted acceleration data based on Euler angle compensation
accyiadj . . . adjusted acceleration data based on Euler angle compensation
vx . . . x-axis velocity
vxo . . . initial x-axis velocity
avevx . . . average value of velocity
delx . . . change in x position between last sample period
x . . . total x position
xo total initial x position
accxo . . . initial x acceleration date
xmm . . . final adjusted x position value
vy . . . y-axis velocity
vyo . . . initial y-axis velocity
avevy . . . average value of velocity
dely . . . change in y position between last sample period
y . . . total position
yo total initial y position
accyo . . . initial y acceleration date
ymm . . . final adjusted y position value

### Web Application

FIGS. 27-28F represent the flow diagrams for the web application identified above. As shown, the web application is related to a multi-pen input device 102 application configured in a centralized pen peer-to-peer configuration. The flow diagrams for the Form Definition functions are shown in more detail to help with understanding the detail nature of the exemplary invention. The file transfer flow diagram is also included. A flow diagram for the forms group is not shown since the basic interface operation is similar to the File Transfer flow diagram.

The file transfer function is illustrated in FIG. 27. The File Transfer web page FIG. 15 is selected by the user clicking on the File Transfer button on another web page (e.g., FIG. 16). The basic function of the exemplary flow diagram is to transfer information to and from a computer system 104 and a pen input device 102. In step 390 a query is sent to the electronic recording system 104 and database 110. In step 392 display information is returned to the client including pen input devices 102 available and configurations. In step 394, the system checks whether the user wants to upload device data. If not, the system checks in step 395 whether the user want to edit configuration information. If so, the system checks in step 398 whether the edit buttons and/or the toggle buttons as shown on the web page have been selected. The system checks in step 400 whether the user has elected to save the configuration and clicked on the submit button in step 402. The system checks in step 404 whether the user wants to download configuration to a pen input device 102. If so, the user can click on a pen input device 102 in the available list or select more than one pen input device 102 by using the shift key in step 406. In step 408, the user can click on the download button to send the configuration information to the pen input device(s) 102. In step 394, the system checks whether the user wants to upload device data. In step 410 the user selects the pen input device(s) 102 to upload data from. In step 412, the user can click on the upload button. After steps 412 or 414, status and data is logged and the program is exited.

FIGS. 28A-28F are flow diagrams for creating a form 124, for example, as illustrated in FIG. 19. The exemplary implementation may be done with different technologies (e.g., thick client with dll's, Java applets, net, etc.). The User Interface (UI) is shown in FIG. 18. The look and feel is simplified for illustrative purposes. The flow diagrams are based on FIG. 18. Additional UI functions are described but not shown. The basic purpose of the form definition application is to define form meta data. E.g., field position information, form number, form name. field numbers, etc. Typically, this information is sent to pen input devices 102. The pen input devices 102 may mark-up a virtual form 124 and then send the information for form data and form presentation collation. Also, devices 122 like tablet PCs all the form information is sent for presentation and raw date presentation. Form 124 is represented to the user. However, there may be a different UI's shown such as thumb nails of all available forms 124. Of course, a blank form 124 would be selected to create a new form 124. FIG. 28A, the creation of a form 124 is presented. The text box creation is not shown, but is the same as the creation of a field box. Note: the words client and server are used in the flow diagram and write-up. Client is taken to be the display and the processor and memory used by the user. Server is used to indicate the hardware and software used to store data and execute the client's requests. The form definition window is selected from another web page by selecting the defined form button. Once the defined form button is selected, the client sends an url requesting display information in step 460. The url is validated in step 464. If not valid, an error message is sent to the client and displayed in step 462. If the url is valid 4, server parses url and queries the database 110 and returns the results to the client in step 468. Then url is validated in step 466. If not valid, error a message is set to the client for display in step 462. If the url is valid, the client parses the information and displays the select form display in step 470. The user selects the form 124 to edit in step 472. An applet uses the cache information from step 470 and displays a blank document object and controls 476. The system checks in step 474 if the applet loads. If not, control returns to step 472. If the applet loads, the system checks whether the user wants to add/move a text/field box in step 478. If so, the system proceeds to step 480 and executes the logic in FIG. 28B. The system checks in step 478 whether the user wants to add/move a text box. If not, the system checks in step 482 whether the user wants to add text to a text box. If so, indicating that the user want to add text, the system proceeds to step 484 and executes the logic in FIG. 28C. If not, the system checks whether the user want to add/move a text/field box in step 478. If the user does not want to add text, the system checks whether the user wants to resize a box In step 486. If so, the system proceeds to step 488 and executes the logic in FIG. 28D. After step 488 is complete, the process returns to step 478. If the user does not want to resize a box 486, the system checks whether the user want to save the form data In step 490. If so, the system proceeds to step 492 and executes the logic in FIG. 28E. After step 492 is complete, the process returns to step 478. If not, the system assumes that the user does not want to save form data 490 and returns.

FIG. 28B illustrates the flow diagram for adding/moving a text/field box. In step 494, the user clicks and holds the mouse button on a field/text box at the bottom (ICON) or within the document object. In step 496, the user drags the box to desired location and an applet track box's position information. In step 498, the system checks whether the user let up on the mouse button. If so, the system checks in step 500 whether the cursor is outside of the document object's boundary. If so, the client (i.e. electronic recording system 104) caches the information and assigns a default field number and displays the box in step 502.

FIG. 28C is flow diagrams illustrating the function add/edit text to a box. In step 504, the user moves the cursor over text and the applet tracks the cursor position. In step 506, the user clicks up/down on the mouse. The applet displays highlighted box. In step 508, the user double clicks on mouse. In step 510, user enters text like a standard windows application (e.g., Visio, etc.). In step 512, applet logs information. In step 514, user clicks outside of box and applet caches information.

FIG. 28D illustrates the flow diagram for resizing a box. In step 516, the user moves the cursor over box and the applet tracks the cursor position. In step 518, the user clicks up/down on the mouse and the applet displays highlighted box. In step 520, the user moves the cursor over parameter of box. In step 522, the user resizes box in a similar manner as a standard windows application (e.g., Visio). In step 524, the applet logs the information. In step 526, the user clicks outside of box. An applet is used to cache information.

FIG. 29E illustrates saving the form data. Any time forms 124 have been created; the user has the option of saving the form 124 in step 490. In order to save the form 124, the cursor is moved to file menu in step 544 and the save as and selects the “save as function” in step 546. After the save as function has been selected, the system loads and paints a browse box in step 526 and displays the form 124 in step 528. In order to name the fields in the field boxes, the cursor is moved to the file name field in step 530. In step 532, the system checks whether the system form file is requested. If not, the cursor over the file button in step 534 and the form information is sent to the database 110 in step 536. If it is desired to rename the form 124, the new form name is typed in step 538 and saved in step 540. FIG. 29F is a continuation of FIG. 29E. Form meta data information exchange. A form 124 is defined by its meta data. A form 124 is referenced, via its form number. A form 124 may be a collation of a number of forms 124. This is different from a form group. Meta data may be defined as follows. Form number, paper size (e.g., 1 equals legal, etc.), number of text boxes, number of field, box followed by actual metal data for the text boxes followed by the field boxes. The box position data may be given relative to the 0,0 reference point or in millimeters, etc. A simple example of the above is //01234567,1′,2,2,′text1′,020,100,030,100,′text2′,100,030,120,030,200,030,210,030,300,030,340,030//

### Edit Logic

FIGS. 29A-29C are software flow diagrams illustrating the edit capabilities of the pen input device. Specifically FIG. 29A illustrates the erase function while FIG. 29B illustrates the highlight function. Finally, FIG. 29C illustrates the red-line function. As mentioned above each of these functions may be initiated when one or more of the pushbuttons 168 (FIG. 6) re depressed. Referring first to FIG. 29A, the system checks whether the erase mode switch, i.e. one or more of the pushbuttons 168 (FIG. 6), has been depressed in step 600. If not, the system logs the status of the erase mode switch in step 602 and returns. If the system detects that the erase mode switch was depressed, the system logs the status of the erase mode switch in step 604 and collects and records Xmm,Ymm erase data while the erase mode switch is depressed. Alternatively, the system can rely on a signal from a force sensor indicating that the eraser end of the pen input device is being pressed against a surface. The Xmm,Ymm erase data is used to define an area on the virtual work space in which ink or text data, previously entered, is to be erased.

FIG. 29B illustrates the highlight function. Referring to FIG. 29, the system checks whether the highlight mode switch, i.e. one or more of the pushbuttons 168 (FIG. 6), has been depressed in step 606. If not, the system logs the status of the erase mode switch in step 608 and returns. If the system detects that the highlight mode switch was depressed, the system logs the status of the highlight mode switch in step 610 and collects and records Xmm,Ymm highlight data while the highlight mode switch is depressed. Alternatively, the system can rely on a signal from a force sensor indicating that the eraser end of the pen input device is being pressed against a surface. The Xmm,Ymm highlight data is used to define an area on the virtual work space in which ink or text data, previously entered, is to be highlighted.

FIG. 29C illustrates the red-line function. Referring to FIG. 29C, the system checks whether the red-line mode switch, i.e. one or more of the pushbuttons 168 (FIG. 6), has been depressed in step 612. If not, the system logs the status of the red-line mode switch in step 614 and returns. If the system detects that the red-line mode switch was depressed, the system logs the status of the red-line mode switch in step 616 and collects and records Xmm,Ymm red-line data while the red-line mode switch is depressed. Alternatively, the system can rely on a signal from a force sensor indicating that the eraser end of the pen input device is being pressed against a surface. The Xmm,Ymm red-line data is used to define an area on the virtual work space in which ink or text data, previously entered, is to be red-lined.

### Electronic Stylus inkXML Browser Application

As mentioned above, the computer system may be web based which means that any applications must be able to run in a browser environment. As shown in FIG. 1, one of the potential input devices is a tablet PC 122. Currently, a draft inkXML standard is available for tablet PCs, as discussed above. However, the draft standard does not provide for inking within a browser window. In order to facilitate communication between the tablet PC 122 and the recording system 104, one aspect of the present invention relates to enabling an electronic stylus to input data, such as inking data, directly on a web page by way of an application that runs in a browser window.

FIG. 30 illustrates an exemplary flow diagram for enabling an inking by an electronic stylus in a browser application. The flow diagram assumes that the browser is open and a conventional inking application is running. The current application translates the ink (a/k/a stroke data) of the electronic stylus on the tablet digitizer to inkXML data and displays the stroke data on the web page.

Referring to FIG. 30, the user initially moves the stylus over a box or “radio button” on the web page to imitate this mode of operation. A radio button may also be used to indicate whether the stroke data is to be displayed as ink on the web page or whether the stroke data is to be converted to text data, for example, by a conventional handwriting recognition application and displayed as text. Initially, the system checks the status of the radio buttons and records the X,Y data of the movement of the electronic stylus relative to the tablet PC digitizer in step 618. The system links the stroke data to the web page in a conventional manner and converts the stroke data to inkXML format, as discussed above. The system checks in step 620 whether the user selected text conversion. If not, the stroke data is displayed on the web page as ink in step 622 and stored in inkXML format in step 624. If text conversion has been selected, the stroke data is converted to text data using the conventional application mentioned above in step 624 and displayed on the web page as text. The system then saves the data in inkXML format in step 624.

### Pen Input Device inkXML Application

FIG. 31 illustrates a software flow diagram illustrating a pen input device inkXML application. Initially in step 626, the system checks whether the pen input device has been pressed against a virtual work surface by monitoring the signals from a force sensor 169. If not, the system loops back to step 626 and awaits a signal from the force sensor 159 (FIG. 6). The force sensor 169 is located within the pen input device 102 and is configured to generate a signal when the pen input device is pressed against a surface. If the force sensor 169 indicates that the pen input device is being pressed against a surface, the raw data, i.e. accelerometer data, is collected and converted to Xmm,Ymm data in the manner discussed above in steps 628 and 630. The Xmm,Ymm data is stored in inkXML format in the manner as discussed above in step 632.

### Creation of Form by Pen Input Device

In accordance with an important aspect of the invention, the system allows for the creation of forms by a computer as well as by a pen input device. FIG. 32 illustrates the process for creating a form by a pen input device. Initially in step 634, the system checks whether the form calibration mode has been selected. As mentioned above, the various operating modes of the pen input device are selected by one or more pushbuttons 168 (FIG. 6). If the form calibration mode has not been selected, the system loops back and waits until the form calibration mode has been selected. Once the system detects that the form calibration mode has been selected, the system checks in step 636 whether the field box mode has been selected. While in the field box mode, the boxes or data fields on a form, for example the boxes 124 and 126 on the form 122 (FIG. 2) can be created. While in the field box mode, the system records stroke data in step 640 during the time the force sensor 169 (FIG. 6) indicates that the pen in put device 102 is being pressed against a work space in step 638.

A stroke mode is also available which enables stroke data to be added to the form. As mentioned above, the stroke data mode is entered by depressing one or more pushbuttons 168 (FIG. 6). The system records all stroke data as Xmm,Ymm data in step 640 as long as the force sensor 169 (FIG. 6) indicates that the pen input device 102 is being pressed against a surface. In step 638. As mentioned above, the stroke data can be entered and displayed as ink on the form or converted to text data by a conventional handwriting recognition program as discussed above. Alternately, the pen input device may be used to point to the location on the form where voice to text data is to be added. In this mode, the user selects the location on the form and simply speaks into the microphone 165 (FIG. 6). A conventional voice to text application, as discussed above, may be used to provide and display text data at the location on the form where the pen input device 102 is pointing. The voice to text and handwriting applications discussed above may also be used for “form data”, i.e. fill in the boxes or data fields on the form.

Single page or multiple page forms may be created. In order to create a multiple page form, the user selects a new page mode by selecting one or more of the pushbuttons 168 (FIG. 6) while in a form calibration mode. Once the new page mode is selected, steps 634-640 are repeated. After the form has been created, either single page or multiple page, the form is stored locally in the pen input device 102. In order to upload the newly created single or multiple page form to the recording system 104 (FIG. 1) or another input device 102, 122 or 123, the user selects one or more of the pushbuttons 168 (FIG. 6) to transmit the newly created form to the other device 104, 102, 122, 123.

### Collaboration Among Multiple Input Devices

The system in accordance with the present invention allows for collaboration of form data between and among input devices. In particular, forms either partially or completely filled in by one input device, such as a pen input device 102 may be sent to another input device and edited, ie. Form data can be erased, highlighted and red-lined by the collaborating pen input device in the manner as discussed above.

Multiple input devices can also collaborate on the completion of a form. In particular, assume that an input device completes one of two fields on a form. Assume that another input device completes another field on the same type of form. In this situation, the data from the forms completed by different input devices can be merged to form a single completed form, thus enabling additional collaboration between input devices. An exemplary flow diagram for merging form data from different input devices is illustrated in FIG. 33.

Referring to FIG. 33, the collaborating input device, which may be a pen input device 102, locally stores both forms to be merged. The collaborating input device selects a first form in step 642. After the first form is selected, the input device selects the boxes or data fields on the form for data collection in step 644. Subsequently in step 646, the system selects another form. In step 648, the input device selects the data fields on the second form for data collection. Next in step 650, the input device selects a new form from the forms library or creates a new form that is to be populated with the data from the other forms. The new populated form may be displayed in step 652 along with any stroke data and editing type data as indicated in steps 654 and 656.

### Voice to Text Application within a Browser Overlay

Voice to text capability as an input mechanism may be used in conjunction with the inking in a browser overlay application. This capability is useful for reporting, defining a form, sending pen input device information and populating a browser form and operating on the information, and using inkXML data from an input device including editing, highlighting, erasing

The overlay application enables various capabilities for input and applications. By having the overlay application reside on top of the browser page, different capabilities are available that would not normally be usable. One example is to have inking within a browser, voice to text, etc. work together as discussed in this application.

The voice to text information is normally converted to text. Although recording it for reporting, linking the voice data to a form field is provided. For the current application, the information may be recorded in the inkXMK format, or converted to text information. The information may then be sent to another application. Likewise, inkXML pen input device data and voice to text data may be used within this inking with in a browser for displaying, editing, etc. This includes the use of erasing, highlighting, and redlining. The overlay inking within a browser application enables many work flows.

The flow chart assumes that the browser is open, the application is open within a browser and the necessary inking program is running. Any combination of input is provided for using this technology—electronic stylus, voice to text, keyboard, pen data input, etc. The flow chart shows a single pass through the process. The process may be executed any number of times depending on the user's work flow. Likewise, data from other sources may populate the web page form. All the inking within a browser, operations must go through the inking within a browser program to be linked to the web page.

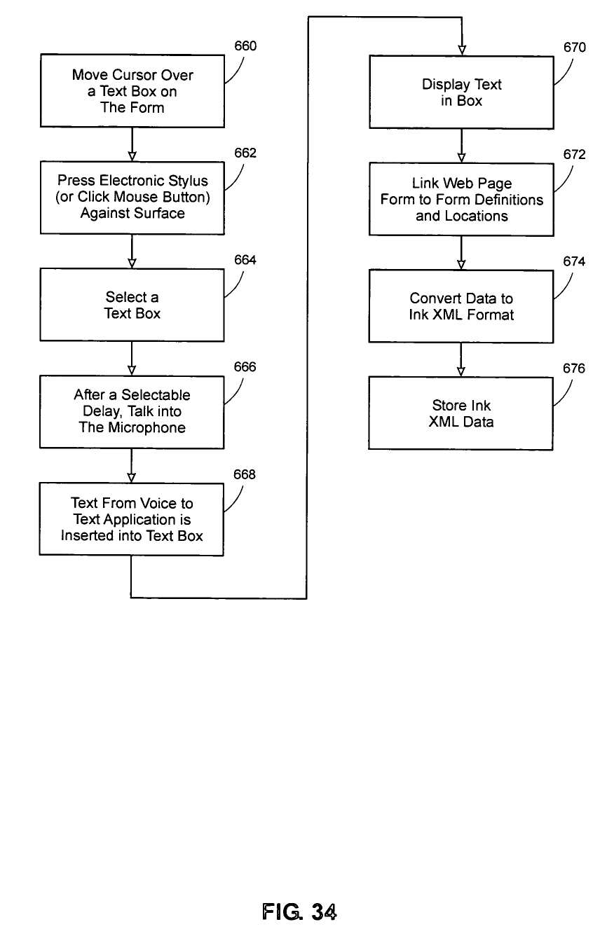

Referring to FIG. 34, initially a form is displayed on a tablet PC being used as an input device. The stylus is moved over the text box on the displayed form in step 660. The stylus is pressed against the digitizer surface in the location of the desired text box. On a standard PC being used as an input device, the cursor is moved over the text box and the mouse button is clicked in steps 662 and 664 to select a text box. After a selectable delay, the user talks into a microphone that forms part of the input device in step 666. The voice data is converted to text data by a voice to text application, such as Dragon NaturallySpeaking® Preferred 6.0, and inserted into the text box in step 668. The form with the newly inserted data is displayed in step 670. In step 672, the form is linked to the form definitions and locations. The form data is then converted to inkXML format in step 674, as discussed above, and stored in steps 674 and 676.

### Input Device Authentication

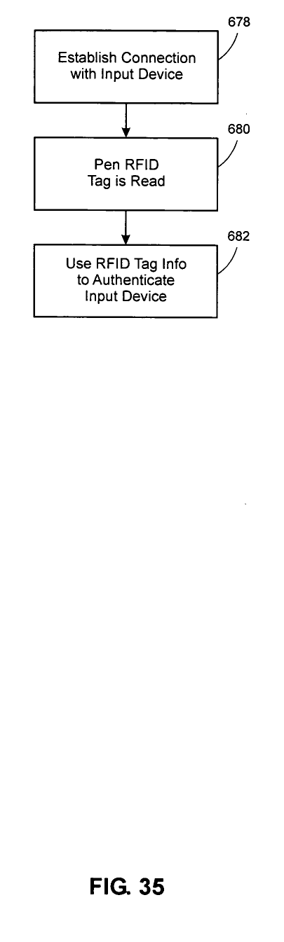

The system also provides for authentication of input devices 102, 122 and 123 connected in a network. In this embodiment, each input device is provided with an RFID tag. After a connection is established with an input device 102, 122 or 123 in the manner discussed above, as illustrated in step 678 (FIG. 35), the RFID tag information of the requesting input device is read by a conventional RFID device reader and transmitted to the network master or other input device in the network in step 680. The network master or other input device then authenticates the input device and only enable communications with requesting input devices that have previously been authorized to participate in the network.

Obviously, many modifications and variations of the present invention are possible in light of the above teachings. Thus, it is to be understood that, within the scope of the appended claims, the invention may be practiced otherwise than is specifically described above.

What is claimed and desired to be secured by a Letters Patent of the United States is:

I claim:

1. A computer system comprising:
one or more pen input devices; and
one or more computers, at least one of said one or more computers configured as a master forming a master-slave configuration with said one or more pen-input devices, wherein said at least one computer, configured as a master, is in communication with a database for storing data for one or more forms, said forms being selectable by said one or more pen input devices and wherein said pen input devices are configured to enable data to be filled in on said a selected form defining form data by way of movements of said one or more pen-input devices and transmitting said data to said master for storage on said database.

2. A computer system as recited in claim 1, wherein said one or more pen input devices are configured to selectively and electronically erase said form data.

3. The computer system as recited in claim 1, wherein said computer system is configured with at least two pen input devices and wherein said pen input devices are configured to enable peer-to-peer wireless communication between said pen-input devices.

4. The computer system as recited in claim 1, wherein said one or more pen input devices are configured to automatically store form data when said master computer is unavailable.

5. The computer system as recited in claim 4, wherein said one or more pen-input devices are configured to automatically transfer data to said master when said master becomes available.

6. The computer system as recited in claim 1, wherein said pen-input system is configured to write on a virtual writing surface.

7. The computer system as recited in claim 1, wherein said database includes at least two forms, said forms being selectable by said one or more pen-input devices.

8. The computer system as recited in claim 1, wherein said forms are stored in said data base by one or more attributes.

9. The computer system as recited in claim 8, wherein one of each form is stored by a form name.

10. The computer system as recited in claim 1, wherein said pen-input device includes a calibration mode which enables the pen-input device to be linked to a virtual writing surface.

11. The computer system as recited in claim 1, wherein said pen-input device is configured as an electronic stylus.

12. The computer system as recited in claim 1, wherein said pen-input device is configured as an inertial device.

13. A pen-input device comprising:
a microprocessor;
a plurality of inertial components for detecting the inertial position of said pen-input device on a virtual surface defining pen-input data;
a user interface for receiving user inputs;
a memory for storing said inertial position data and said user inputs under the control of said microprocessor;
a communications module for enabling said pen-input device to communicate with remote devices under the control of said microprocessor;

14. The pen-input device as recited in claim 13, wherein said pen-input device is configured to enable virtual erasing of said pen-input data.

15. The pen-input device as recited in claim 13, wherein said pen-input device is configured with at least three modes of operation; an on/off mode, a calibration mode, and a write mode.

16. The pen-input device as recited in claim 15, wherein at least three modes of operation are selectable by way of said user interface.

17. The pen-input device as recited in claim 16, wherein said user interface includes at least one push button.

18. The pen-input device as recited in claim 13, wherein said pen-input device also includes an ink cartridge.

19. The pen-input device as recited in claim 13, wherein said pen-input device is configured to automatically transfer pen-input data to a remote device.

20. The pen-input device as recited in claim 13, wherein aid pen-input device is configured to enable form data stored in a remote location to be selectably uploaded.

21. The pen-input device as recited in claim 20, wherein said pen-input device is configured to enable data input into a plurality of selectable forms.

22. The pen-input device as recited in claim 21, wherein said pen-input device is configured to communicate with another pen-input device forming a peer-to-peer network.

23. The pen-input device as recited in claim 22, wherein said pen-input device is configured to communicate with a remote host computer.

24. The pen-input device as recited in claim 15, wherein said pen-input device is configured so that its operating configuration can be configured by a remote device.

25. The pen-input device as recited in claim 15, wherein said pen-input device is configured to select one or more forms from a remote source for the purpose of providing form data.

26. A computer system comprising:
at least one pen input devices; and
an electronic recording system for storing data from one or more pen input devices, wherein said at least one pen input device provided with an electronic edit function.

27. A computer system as recited in claim 26, wherein said electronic edit function is an electronic erase function.

28. A computer system as recited in claim 26, wherein said electronic edit function is an electronic highlight function.

29. A computer system as recited in claim 26, wherein said electronic edit function is an electronic red-line function.

30. A computer system comprising:
at least one pen input devices; and
an electronic recording system for storing data from one or more pen input devices, wherein data from said pen input device is stored as inkXML data

31. The computer system as recited in claim 30, wherein said at least one pen input device is connected in a network with at least one other input device and data between said at least one pen input device and said other input device is transmitted in inkXML format.

32. A computer system comprising:
at least one pen input devices; and
an electronic recording system for storing data from one or more pen input devices, wherein said pen input device is configured to merge data from multiple forms.

33. A computer system comprising:
at least one pen input devices; and
an electronic recording system for storing data from one or more pen input devices, wherein said pen input device is configured to create a form.

34. A computer system comprising:
at least one tablet PC; and
an electronic stylus for inputting data to said tablet PC; and
an application for enabling said electronic stylus to input data to an open browser window running on said tablet PC.

35. A computer system comprising:
a computer system including an input devices ,said input device is configured for wireless communications and having an RFID tag, wherein said RFID tag data is used to enable communications relative to said input device.

36. A computer system comprising:
a memory and a display for displaying at least one form;
an input device for pointing to said form;
a microphone;
a processor; and
means for converting voice data to text data and inserted said text data onto a location on said form selected by said input device.
